(19) United States
(12) Patent Application Publication
(10) Pub. No.: US 2015/0287082 A1
(43) Pub. Date: Oct. 8, 2015

(54) Online Communication of Qualitative Information Describing Service Providers

(71) Applicant: MediSystemZ LLC, St. Louis, MO (US)

(72) Inventor: Banke Agarwal, St. Louis, MO (US)

(21) Appl. No.: 14/678,086

(22) Filed: Apr. 3, 2015

Related U.S. Application Data
(60) Provisional application No. 61/974,803, filed on Apr. 3, 2014.

(51) Int. Cl. G06Q 30/02; G06Q 50/22

(52) U.S. Cl. CPC G06Q 30/0256; G06Q 30/0269; G06Q 50/22

(57) ABSTRACT

A system receives user input at a website. The input describes service provider qualities and/or attributes. The user input is compared with stored qualities and/or attributes corresponding to service providers, the stored qualities and/or attributes having been specified in response to requests by the system for qualitative information from individuals determined to have personal knowledge of service providers described in the system. The individuals are in groups, each group having a corresponding perspective from which to evaluate service providers, at least some of the qualitative information having been specified as to a given provider in response to a self-evaluation by the given provider with respect to the stored qualities and/or attributes. The computer(s) identify service providers described in the system as having service provider qualities and/or attributes input by the user.

### CROSS-REFERENCE TO RELATED APPLICATION

This application claims the benefit of U.S. Provisional Application No. 61/974,803, filed on Apr. 3, 2014. The entire disclosure of the above application is incorporated herein by reference.

### FIELD

The present disclosure relates to systems and methods for online communication of qualitative information describing service providers.

### BACKGROUND

This section provides background information related to the present disclosure which is not necessarily prior art.

People who wish to obtain medical treatment typically look for information to help them find and choose a physician best qualified to diagnose and manage their medical conditions while treating them with dignity. Individual patients have diverse healthcare needs. Patients may also have diverse preferences with regard to a physician's personality traits and also as to how members of a physician's staff provide customer service.

### SUMMARY

This section provides a general summary of the disclosure, and is not a comprehensive disclosure of its full scope or all of its features.

In one example embodiment, the present disclosure is directed to a system including a network. One or more computers are configured in the network to receive user input at a website. The input describes one or more service provider qualities and/or attributes. The computer(s) compare the user input with stored qualities and/or attributes corresponding to a plurality of service providers, the stored qualities and/or attributes having been specified in response to requests by the system for qualitative information from individuals determined by the system to have personal knowledge of service providers described in the system, the individuals included in a plurality of groups, each group treated by the system as having a corresponding perspective from which to evaluate service providers, at least some of the qualitative information having been specified as to a given provider in response to a self-evaluation by the given provider with respect to one or more of the stored qualities and/or attributes. Based on the comparing, the computer(s) identify one or more service providers described in the system as having one or more of the service provider qualities and/or attributes input by the user.

In another example embodiment, the present disclosure is directed to a system for providing information by which to evaluate providers of professional services. The system includes a network and computer(s) configured in the network to provide a website for receiving input requested from a plurality of evaluators to evaluate a plurality of providers of professional services, where for each provider, the evaluators of the provider include the provider, clients of the provider, and peers of the provider. For each provider, the website is configured to present, to each client evaluator and to each peer evaluator, one or more professional attributes selected by the provider as the provider's professional attributes, and as to each professional attribute selected by the provider, the website is configured to request each client evaluator and each peer evaluator to provide an opinion as to whether the evaluator recommends the provider for that professional attribute. The website is configured to request each client evaluator and each peer evaluator to select one or more qualities as best describing the provider. The website also is configured to provide an evaluation of the provider that indicates (a) the most commonly provided opinions as to the provider-selected professional attributes, and (b) the qualities most commonly selected as best describing the provider.

In yet another example embodiment, the present disclosure is directed to a system for facilitating evaluation of providers of professional services. The system includes a network, and computer(s) configured in the network to request online input from each of a plurality of evaluators to evaluate a plurality of providers of professional services, where for each provider, evaluators include the provider, clients of the provider, and peers of the provider, and where the peers and clients are requested to provide at least some of the input confidentially in qualitative terms. The computer(s) are configured to receive confidentially from each client evaluator (a) an evaluation of a self-evaluation by the provider and (b) an evaluation of the provider from the perspective of the client evaluator as a client of the provider. The computer(s) receive confidentially from each peer evaluator (a) an evaluation of the self-evaluation by the provider and (b) an evaluation of the provider from the perspective of the peer evaluator as a peer of the provider. The computer(s) analyze the qualitative terms provided in the evaluations to determine a plurality of the qualitative terms describing the provider, and provide the qualitative terms in a computer-searchable format.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a diagram of a system for facilitating evaluation of professional service providers in accordance with one embodiment of the disclosure;

FIG. 2 is a flow diagram of a method for facilitating evaluation of professional services providers in accordance with one embodiment of the disclosure;

FIG. 3A is an illustration of a communication from a professional services provider to a client in accordance with one embodiment of the disclosure;

FIGS. 3B-3Q are illustrations of computer screens generated in accordance with one embodiment of the disclosure;

FIGS. 4A-4O are illustrations of computer screens generated in accordance with one embodiment of the disclosure;

FIGS. 5A-5D are illustrations of computer screens generated in accordance with one embodiment of the disclosure; and

FIGS. 6A-6B are illustrations of computer screens generated in accordance with one embodiment of the disclosure.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

The inventor has observed that much of the information for finding physicians that is available on the Internet is not particularly meaningful and at times not even credible. Physician rating websites typically list only a few reviews for each physician. Since the reviews are typically unverified and unauthenticated, the websites often serve to empower a few disgruntled patients and employees, and sometimes competitors, to disparage physicians. Such reviews can be difficult if not impossible to remove from the websites.

Even where online information is assumed to be accurate, The inventor has observed that the information typically cannot describe a particular physician's professional capabilities or personal attributes that might be relevant to a particular prospective patient. Physician ratings based, e.g., on letter grades, numbers of stars, etc. typically do not provide much information and are not well suited to address specific concerns and preferences of prospective patients. Each potential patient has individual medical needs and also individual preferences as to how medical services might be delivered to him/her. Even where a “1 star to 5 star” rating system might be supplemented by user comments, there often is no online structure provided to assist a reader in selectively evaluating the user comments. Typically one must read through a string of comments that are not coordinated with one another in terms of whatever information they might provide. Such comments can be tiring and tiresome to read and are not necessarily addressed to a specific need or question that the reader may have. In short, conventional Internet rating systems are not adequate to effectively communicate those of a physician's qualities and attributes that a given prospective patient would seek in a physician. What a patient may seek in a physician's qualities and attributes can vary from patient to patient.

Additionally, the inventor has observed that unless a prospective patient also happens to be a physician, the prospective patient typically does not know whom to consult in order to find a physician having the medical expertise most appropriate to meet the patient's individual medical needs. Other patients may recommend their own physicians, but a patient typically cannot evaluate a physician's medical skills from the same perspective as another physician. Although there are online and other advertisements by many hospitals and by some physicians, such advertisements tend to be poor substitutes for recommendations of a physician by other physicians who have personal knowledge of the physician's medical capability.

Accordingly, in various embodiments, the present disclosure is directed to a system for providing qualitative information by which to evaluate providers of professional services. Multiple evaluators can provide input to a website for facilitating evaluation of a professional services provider. For each provider, evaluators include the provider himself/herself, clients of the provider, and peers of the provider. In some embodiments, clients and/or peers of a given provider can indicate whether and how much they agree with the provider's self-evaluation.

In various embodiments, a website presents results of two-way communication between a physician and his/her patients. The website also presents results of two-way communication between a physician and his/her peers. These two-way communications can provide a direct measurement of how well the physician exhibits particular qualities. A potential client is provided with a capability to search the website for one or more specific attributes and/or qualities that may be attributed to a provider by the provider himself/herself, the provider's clients and/or the provider's peers. In this way, for example, a potential medical patient may locate a physician that is considered by most of his/her patients and/or peers to have a specific quality or attribute sought by the potential patient. In contrast to conventional online rating systems, various embodiments are structured so as to keep user-entered information meaningful as to a given physician, without encouraging “group-think” among the users. In various embodiments, quality can be communicated effectively over the Internet.

It should be noted that although various embodiments are described in the present disclosure in relation to providers of medical services and potential patients of medical providers, the disclosure is not so limited. Embodiments are possible in relation to evaluating various types of professional services providers, including but not limited to providers of legal services, educational services, etc.

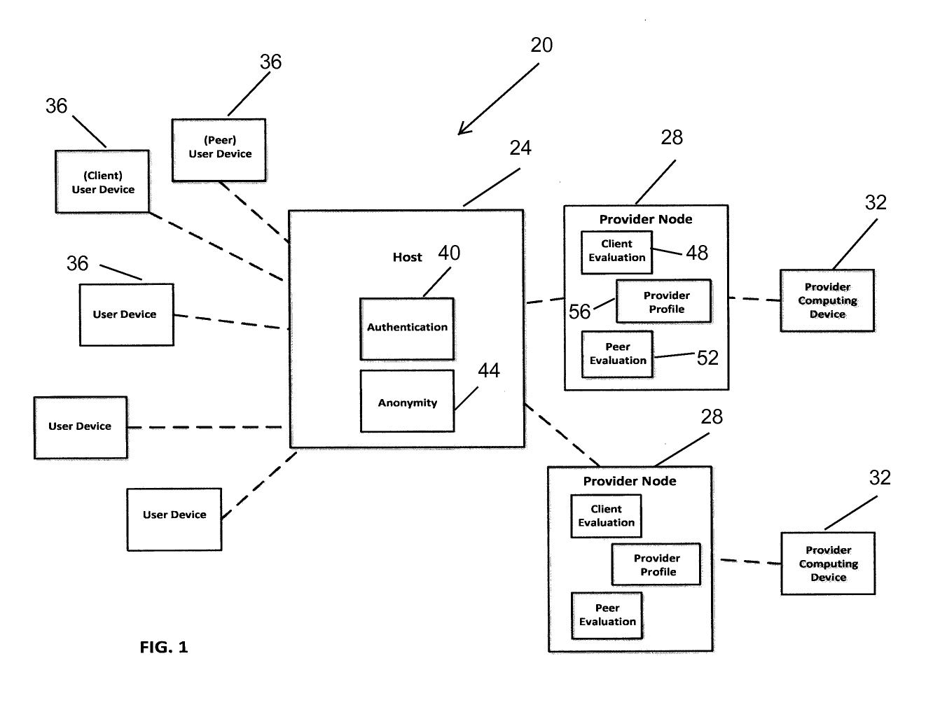

One example configuration of a system for facilitating evaluation of professional service providers is indicated schematically in FIG. 1 by reference number 20. In various embodiments, the system 20 may be used, e.g., by potential medical patients, physicians and/or members of the general public to collect information about medical services providers, to identify physicians who appear to meet particular healthcare needs and customer service preferences of the users. In one example implementation a host 24 is configured to make the system 20 available to users via a website on the Internet.

Various components of the system 20, including but not limited to the host 24, may include one or more servers, routers, personal computers, combinations of the foregoing, various additional or alternative combinations of processors and memory, etc. Additionally or alternatively, various components of the system 20 may be cloud-based. It should be noted generally that various hardware and/or software configurations could be used to provide capabilities of the various system components as described herein. It also should be noted that the term “software” is to be interpreted broadly in the present disclosure. “Software” can take many forms, including but not limited to source, object, and/or executable code that can include and/or refer to a plurality of objects, modules, libraries, services, etc., and that can be stored, distributed, downloaded, combined and/or accessed in various ways.

The host 24 includes and/or has access to each of a plurality of provider nodes 28. In the present example embodiment, each provider node 28 is associated with and accessible by a specific provider of medical services, e.g., via a computing device 32. For example, a physician may access an associated provider node 28 by using a computer in his/her office, a personal computer in the physician's home, etc. Additionally or alternatively, a physician may use any of various computers and/or computing devices such as smart phones, tablets, etc., to access an associated provider node 28. Communications between a provider computing device 32 and a provider node 28 may be, e.g., via the Internet, local- and/or wide-area network(s), cellular network(s), wired connection(s), combinations of the foregoing, etc.

A provider node 28 may include, have access to, and/or may be included in one or more servers, routers, personal computers, personal computing devices, combinations of the foregoing, various additional or alternative combinations of processors and memory, etc. Although two provider nodes 28 are shown in FIG. 1, more than two provider nodes are included in the system 20 in various embodiments. Substantially more than two medical services providers typically may make use of a system such as the system 24. Although the two provider nodes 28 of FIG. 1 are shown as configured separately from the host 24, in various embodiments provider node(s) 28 may be at least partially resident on the host 24.

Users of the system 20 may, e.g., communicate with the host 24 via user devices 36, which may include, e.g., personal computers, laptops, smart phones, tablets, etc. In addition to members of the general public, users of the network 20 may include potential and/or actual patients and/or peers, e.g., of physicians represented by provider nodes 28. The host 24 includes, or has access to, an authentication capability 40 for the purpose of authenticating a user of the system 20 as a true client or peer of one of the providers for which a provider node 28 is included in the system 20. The host 24 also includes, or has access to, an anonymity capability 44 whereby an input to the system 20 from an authenticated peer or client of the system 20 is maintained anonymously by the system 20, i.e., without attribution of the input to the peer or client who provided the input, and so as to prevent the system 20 from being used by anyone to identify and connect the peer or client with the input.

Information input, e.g., by authenticated patients and/or authenticated peers of a given medical services provider may be stored respectively as client evaluation data 48 and peer evaluation data 52, e.g., in relation to the provider node 28 associated with the given provider. Although client evaluation data 48 and peer evaluation data 52 are shown in FIG. 1 as being included in provider nodes 28, the system is not so limited. In various embodiments, client evaluation data 48 and/or peer evaluation data 52 may reside in one or more databases on the host 24, in the cloud, etc. As further described below, each provider node 28 also includes, or has access to, a provider profile 56 describing the physician associated with the provider node 28. The system 20 makes client evaluation data 48 and peer evaluation data 52 included in provider profiles 56 available for searching by users, e.g., through the host 24.

In the present example embodiment, the system 20 provides information by which users may evaluate a plurality of physicians. Such information includes self-evaluations by the physicians as well as qualitative evaluations by authenticated patients and peers of the physicians. Qualitative evaluations by authenticated patients and/or peers of a given physician can include patients' and peers' opinions, e.g., as to the accuracy of the physician's self-evaluation. In some embodiments, and as further described below, a physician makes his/her provider profile 56 available, e.g., through a website of the system 20, to users who may wish to perform searches in the system 20 for a physician based on users' individual qualitative criteria. In the present example embodiment, a physician's provider profile 56 includes information that is based on, e.g., summarizes, authenticated patients' and peers' evaluative information.

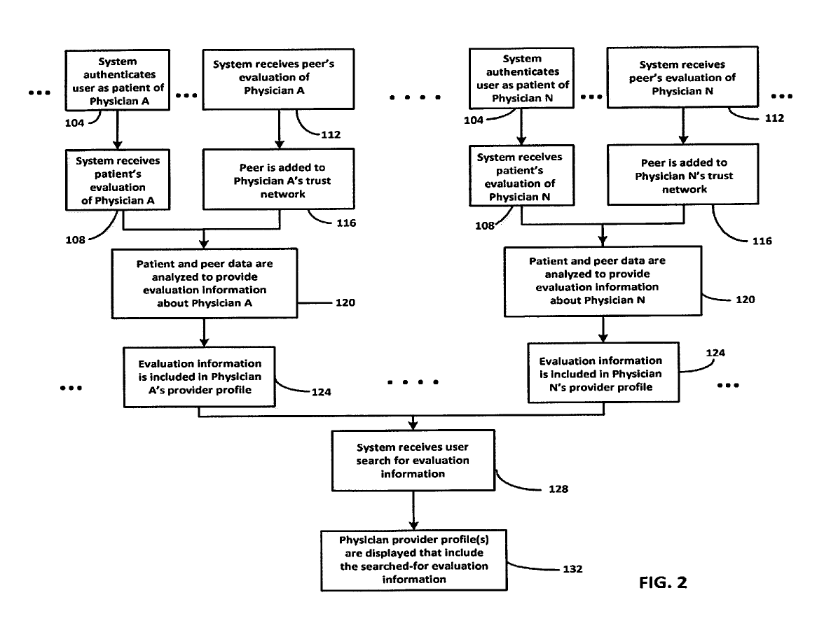

One example implementation of a method for facilitating evaluation of professional services providers is indicated generally in FIG. 2 by reference number 100 and shall be described with reference to the example system 20 of FIG. 1. In process 104 the system 20 is contacted, e.g., through a website of the system 20, by a user who is a patient of a medical physician associated with the system 20, e.g., “Physician A” as shown in FIG. 2, and the system 20 authenticates the user as a true patient of Physician A. In process 108 the system receives from the authenticated patient, e.g., through the website, a qualitative evaluation of Physician A, e.g., as further described below. The processes 104 and 108 may be performed in relation to each of a plurality of patients of Physician A who contact the system 20. In some embodiments, patient-provided evaluations may be stored, e.g., as client evaluation data 48 associated with Physician A.

In process 112 the system 20 is contacted, e.g., via the website, by a peer of Physician A, e.g., in response to an invitation from Physician A, and receives from the peer a qualitative evaluation of Physician A. In process 116 the peer is added to Physician A's trust network. The processes 112 and 116 may be performed in relation to each of a plurality of peers of Physician A who contact the system 20. In some embodiments, peer-provided evaluations may be stored, e.g., as peer evaluation data 52 associated with Physician A.

In process 120 the system 20 analyzes client evaluation data 48 and peer evaluation data 52 for Physician A to obtain, e.g., one or more evaluation summaries and other or additional information evaluating Physician A. For example, a summary of client evaluation data 48 might indicate that a majority (or, e.g., a specific percentage) of Physician A's patients consider one or more specific qualities as best describing Physician A (e.g., that Physician A is competent, considerate, etc.) A similar summary of peer evaluation data 52 might indicate that a majority (or, e.g., a specific percentage) of Physician A's peers consider one or more specific qualities as best describing Physician A. As another example, summaries of client evaluation data 48 and/or peer evaluation data 52 might indicate agreement by patients and/or peers as to whether Physician A has accurately attributed to himself/herself one or more specific attributes (e.g., whether Physician A provides clear actionable expert medical advice, etc.) In addition to the foregoing examples, there are numerous ways in which client evaluation data 48 and/or peer evaluation data 52 might be analyzed, combined, summarized or otherwise used to provide qualitative information about Physician A.

In process 124 the system 20 includes the summary and/or other evaluation information in the provider profile 56 for Physician A. In various implementations the processes 104, 108, 112, 116, 120 and 124 are repeated as to each of a plurality of physicians associated with in the system 20. The evaluation data given by a plurality of physicians, and by patients and peers of the physicians, are included in the physicians' provider profiles 56, which in the present example embodiment are made available for searching by users of the system 20.

In process 128 a user accesses the website of the system 20 and may enter search terms upon which to search for a physician. It should be noted that a user's search terms could include qualitative terms, e.g., “considerate,” as well as (or even in place of) objective search terms, e.g., terms specifying a particular medical subspecialty. In process 132 the system 20 returns information identifying one or more physicians that meet the user's search criteria. Specifically and for example, the system 20 may display information from each physician's provider profile 56 that meets the search criteria.

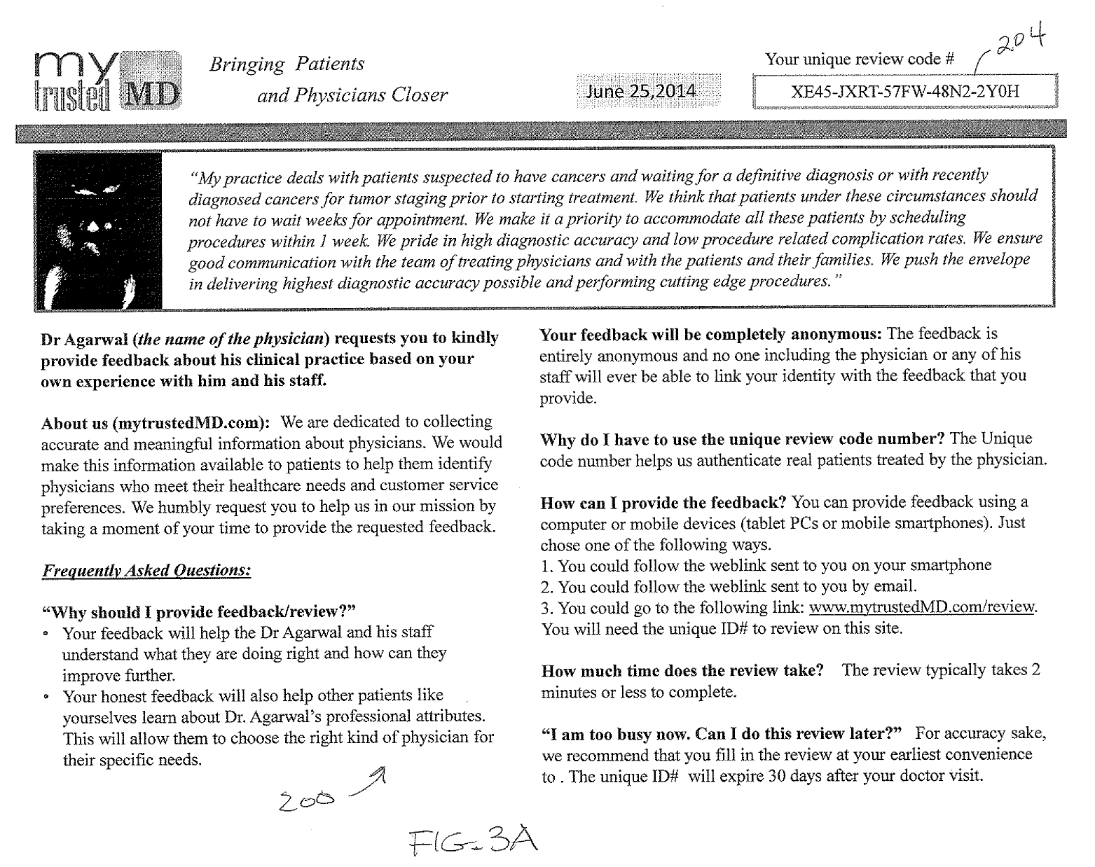

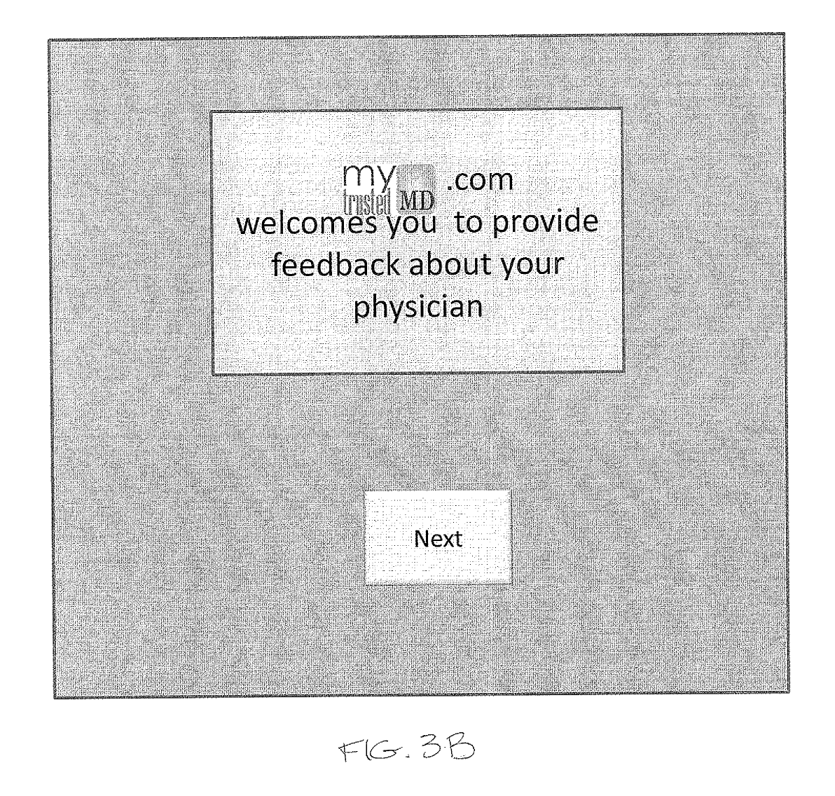

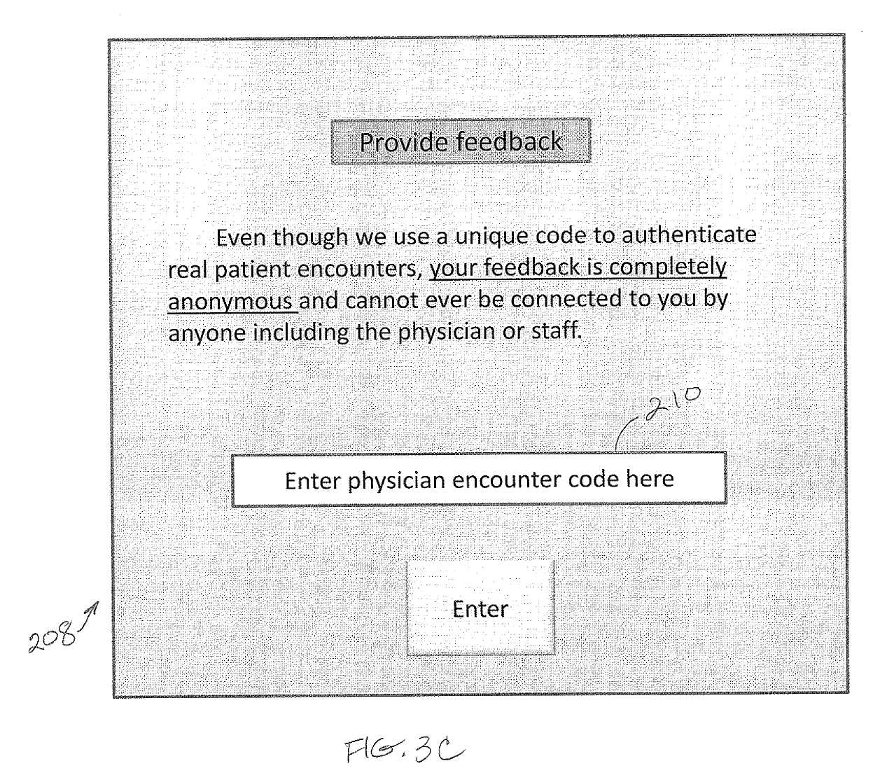

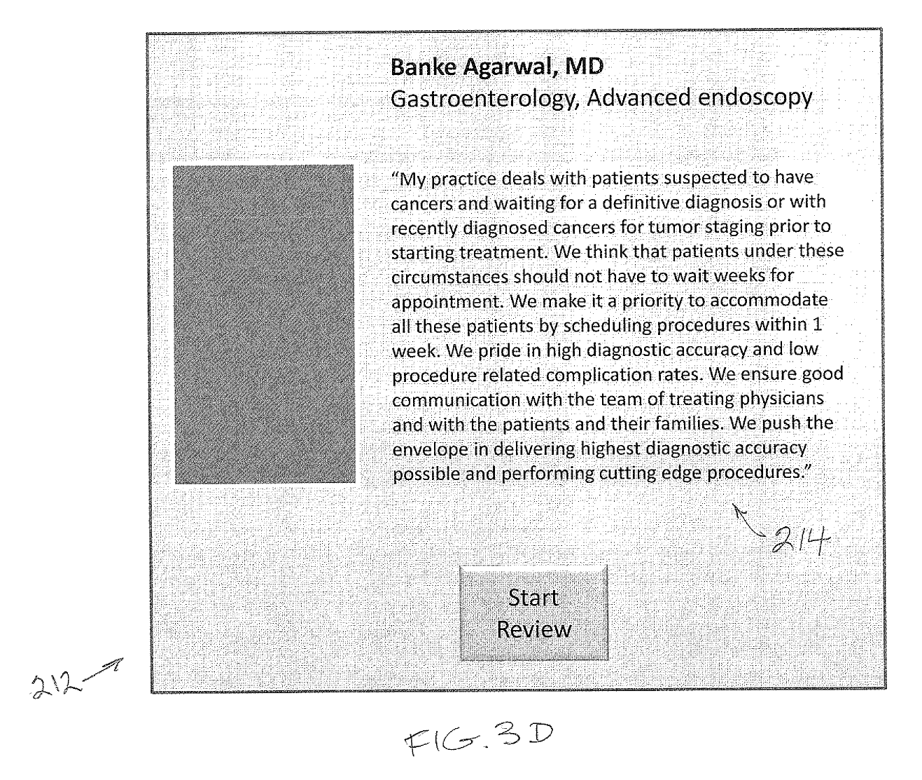

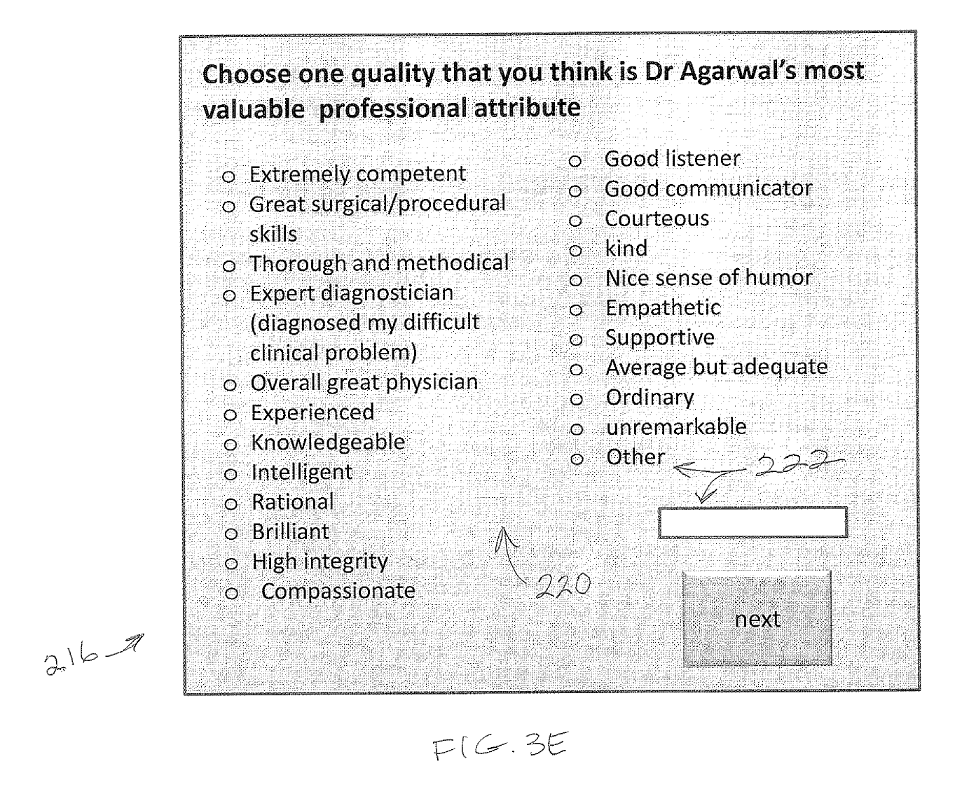

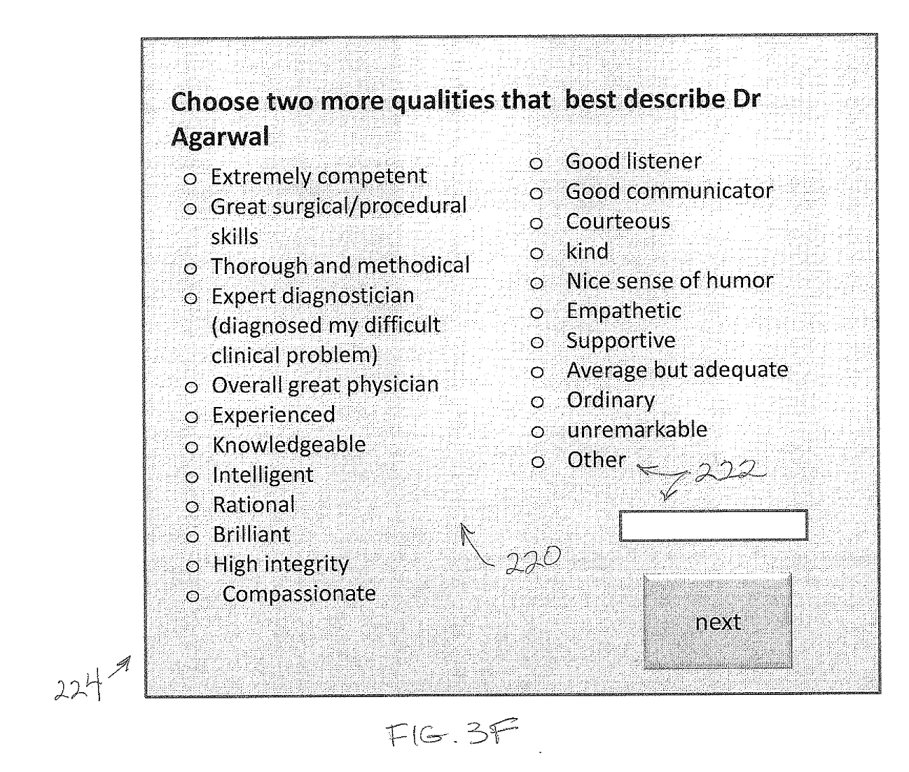

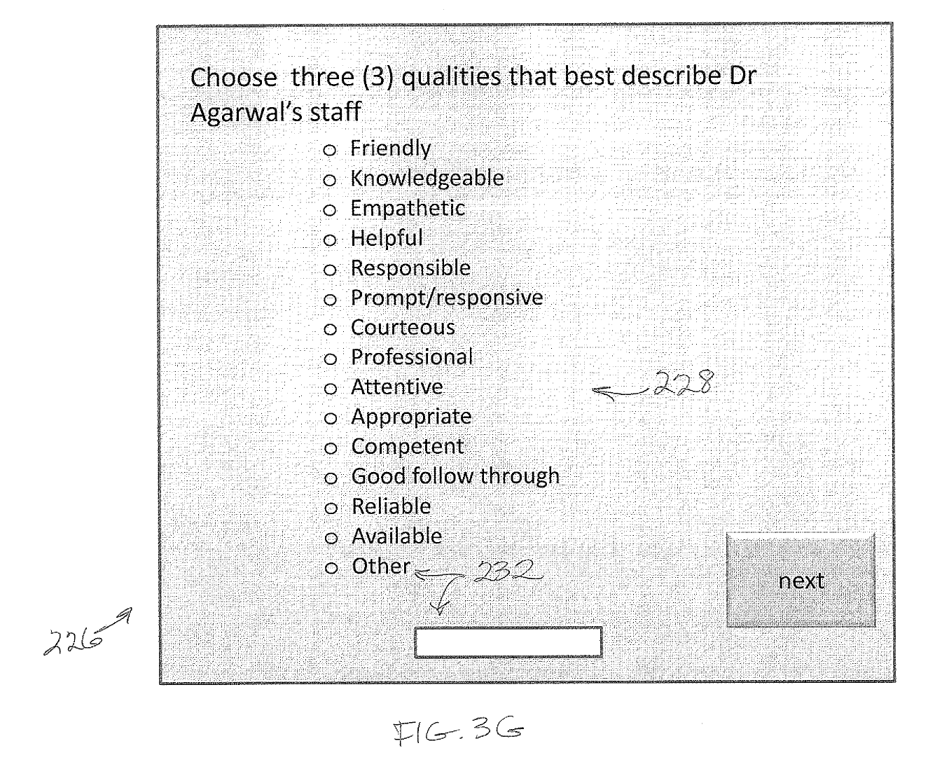

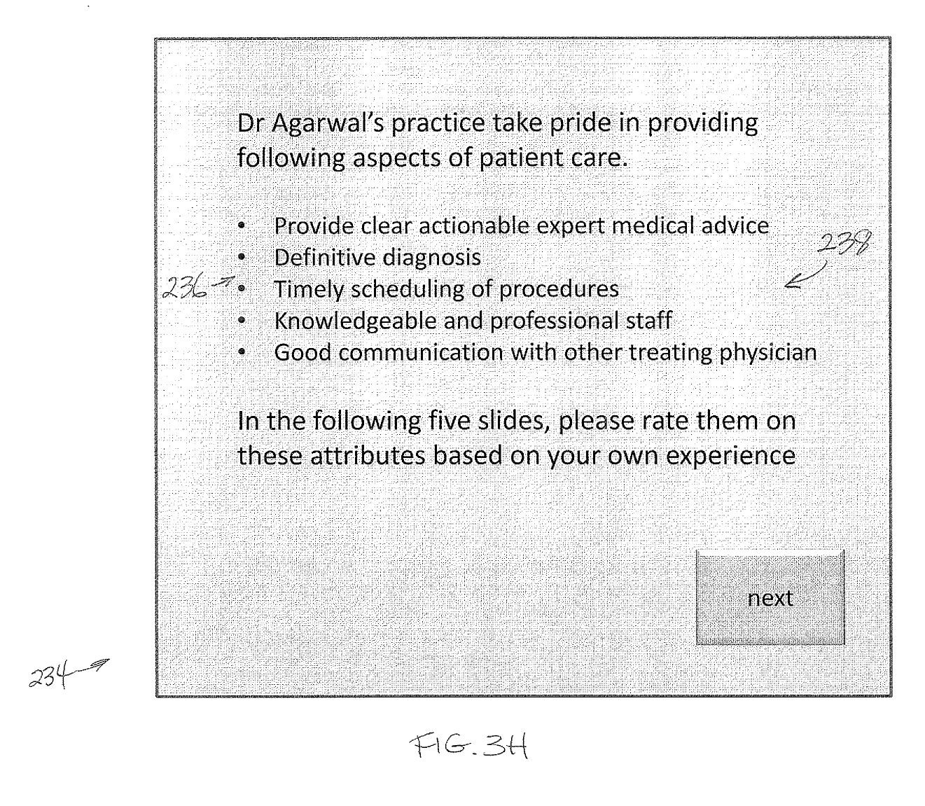

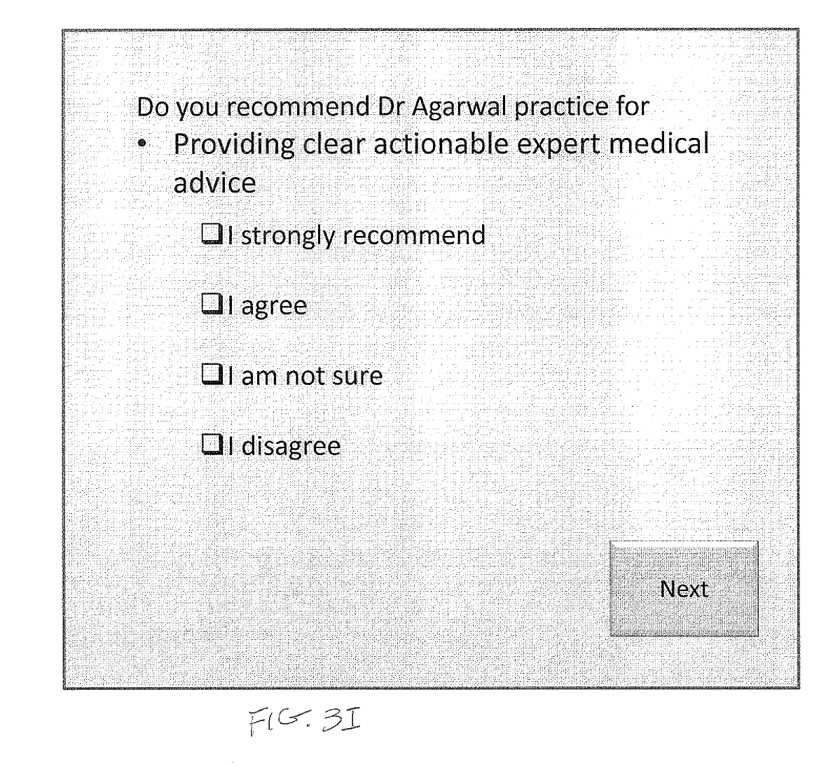

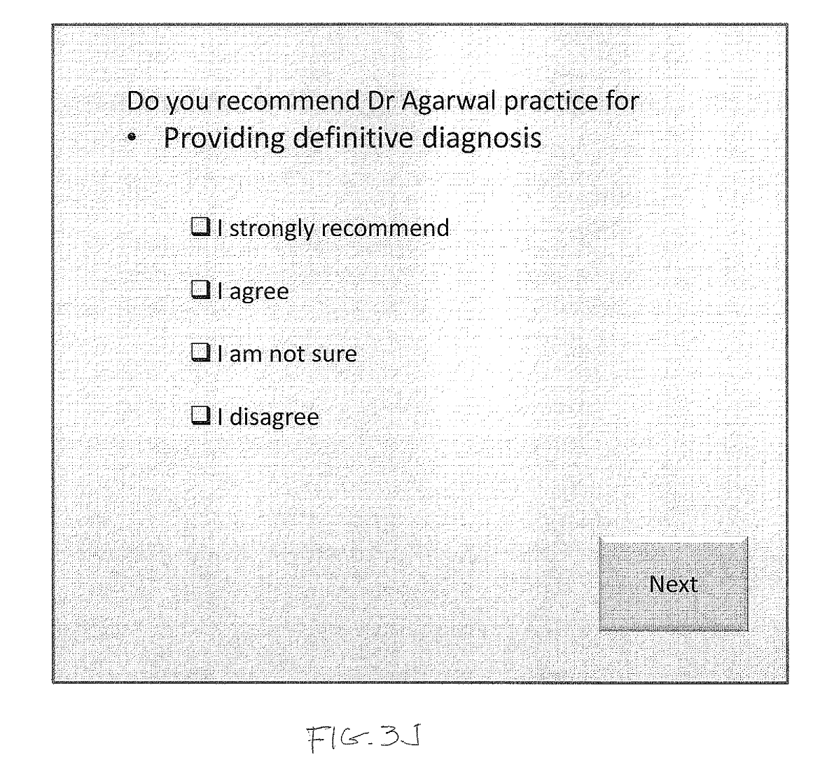

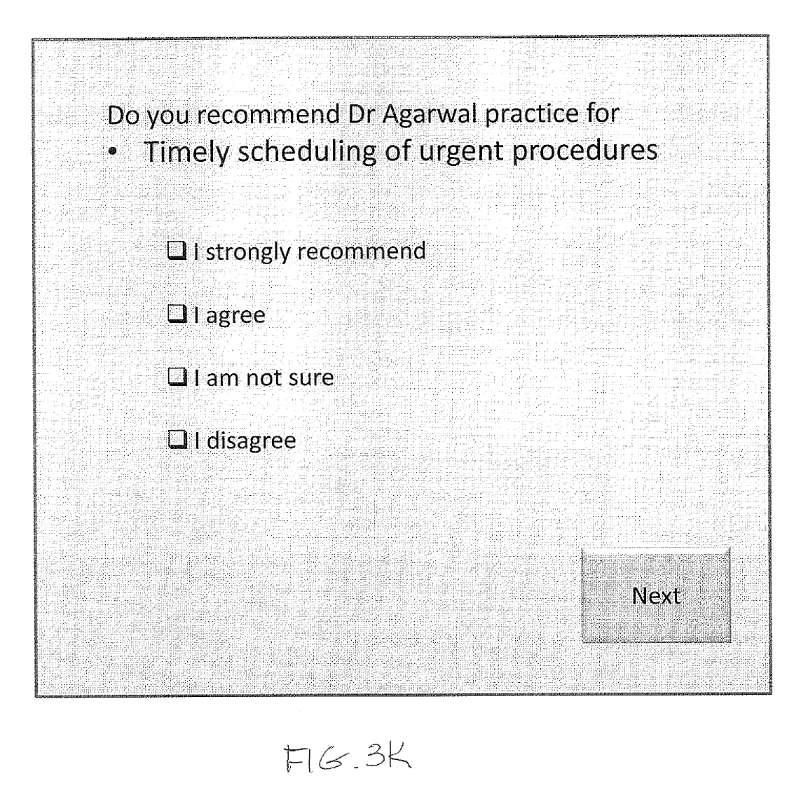

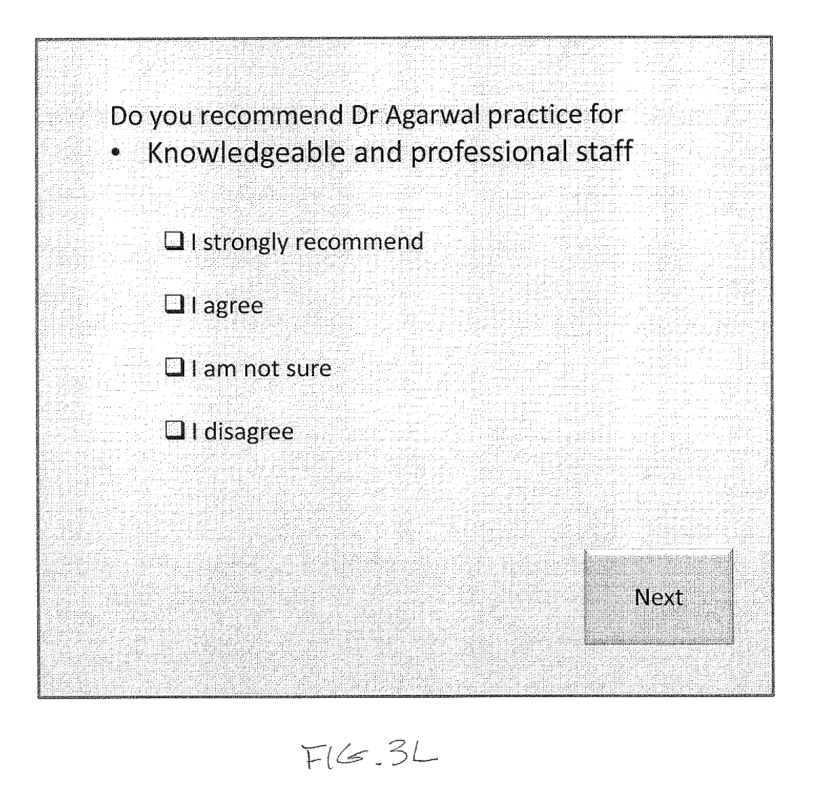

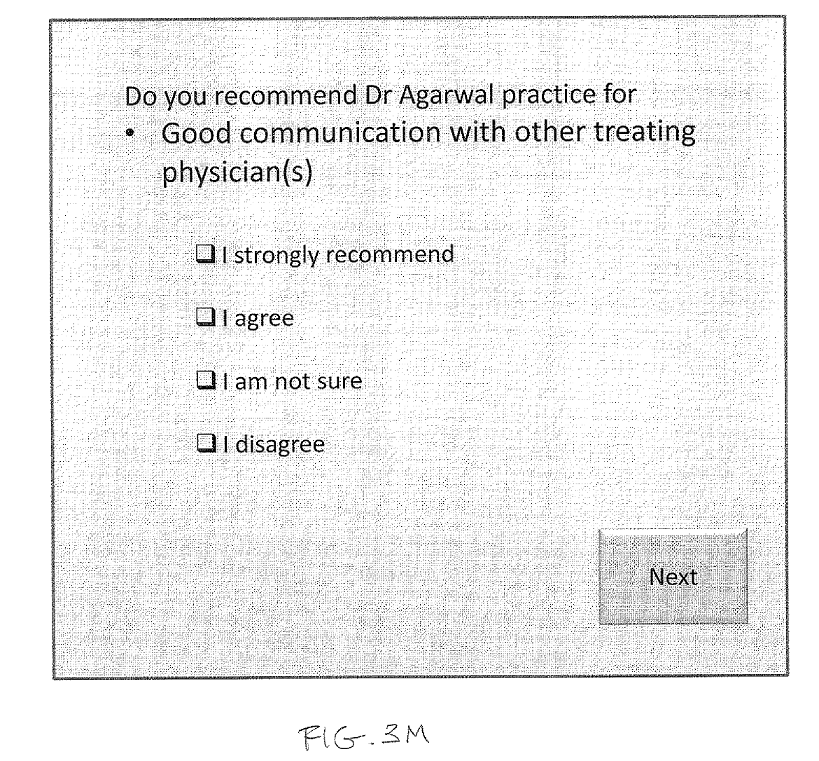

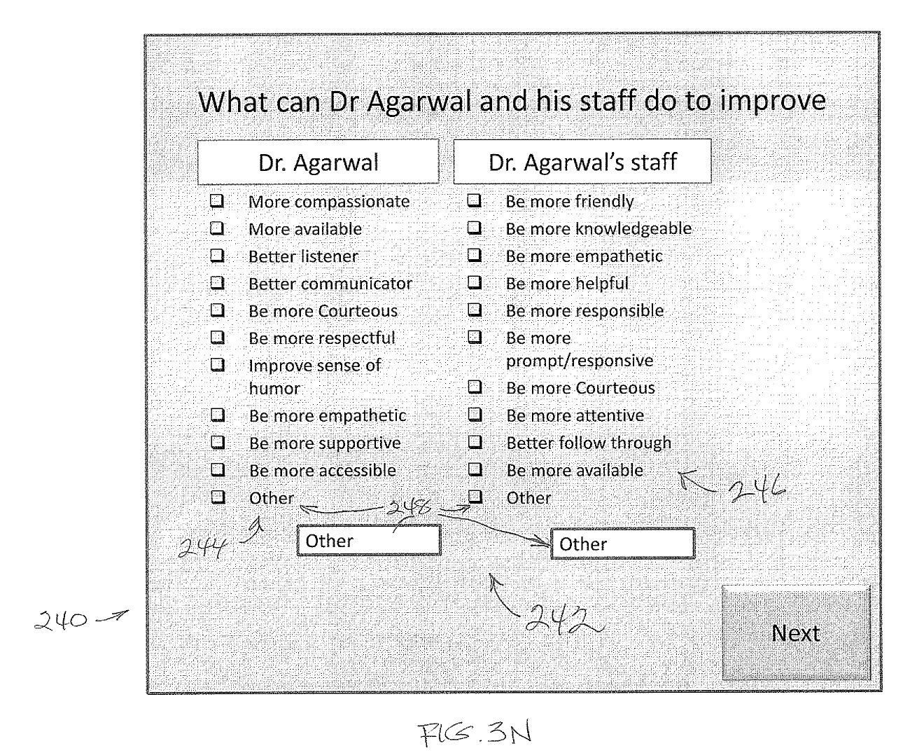

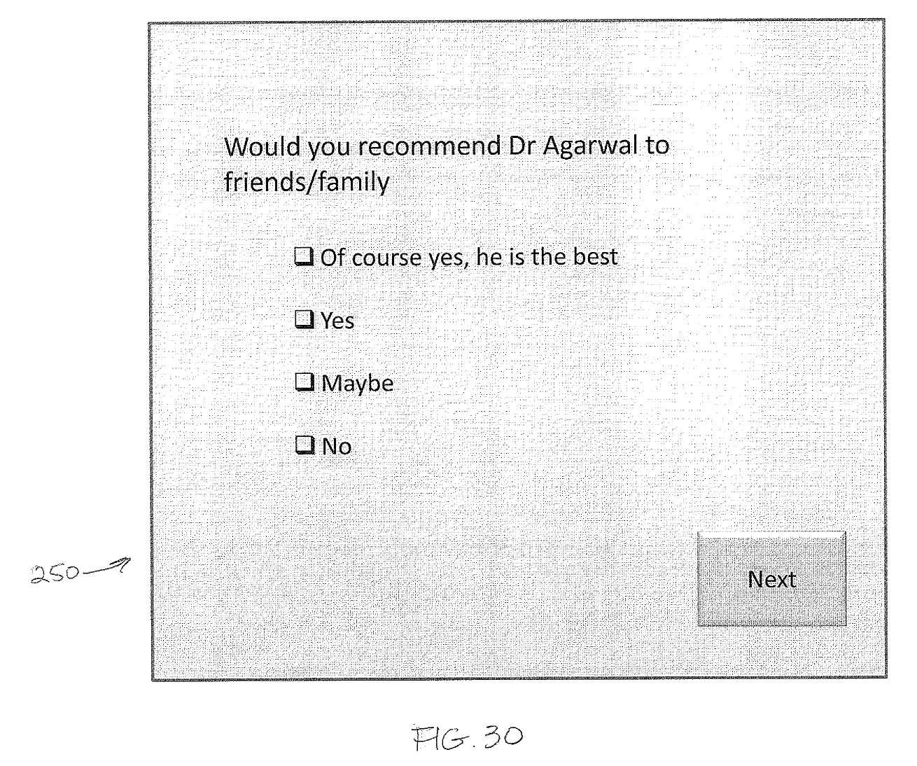

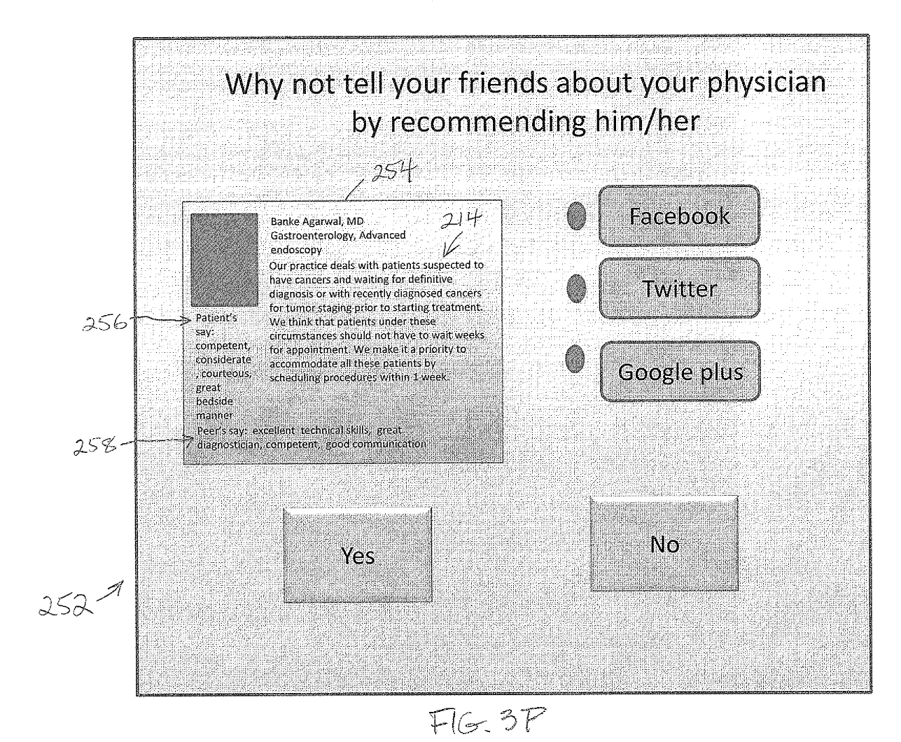

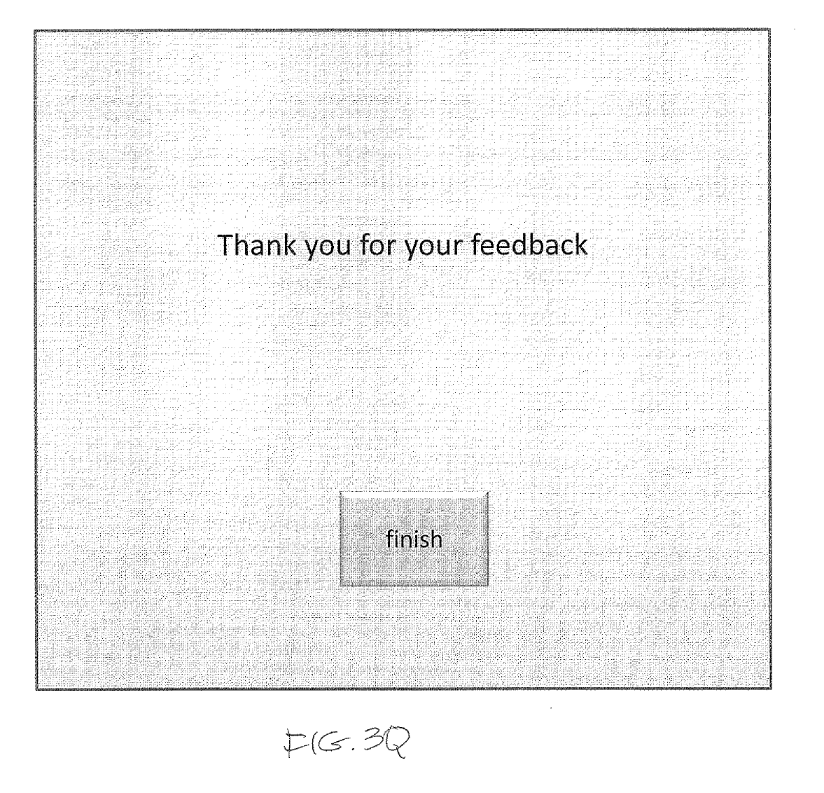

Another example implementation of a method of facilitating evaluation of professional service providers shall be described with reference to the example system 20 of FIG. 1. In various embodiments of the disclosure, a patient of a given physician is requested, personally and/or in writing, to provide feedback about the physician to the system 20. An example letter from a physician to a patient is indicated generally in FIG. 3A by reference number 200. A patient is given a unique encounter code 204 whereby the patient may be authenticated by the authentication capability 40 as an actual patient of the physician. A patient may, e.g., use a user device 36 to provide feedback through the website of the system 20, e.g., as shown in FIGS. 3B through 3Q. The patient proceeds from a welcome screen shown in FIG. 3B to a screen 208 shown in FIG. 3C. The patient may choose to provide feedback and enters his/her unique encounter code 204 into an area 210. As shown in FIG. 3D, an introductory screen 212 may include a self-profile 214 of the physician of his/her attributes and focus of practice. It should be noted generally that sequences in which screens may be displayed can vary in various embodiments, and the number, sequencing and content of screens as described herein are exemplary only.

When the patient starts a review of the physician, a screen is displayed, e.g., as indicated generally in FIG. 3E by reference number 216. The patient is asked to select one quality 220 that the patient thinks is the most valuable professional attribute. Various buttons, links, menus, areas, etc. may be provided by and/or in which the patient may select one from a plurality of qualities 220. It should be noted that the qualities 220 are of various types, e.g., relating to professional competency, personality, intelligence, character, etc. In the present example embodiment, the patient may optionally enter an “Other” quality 222 of his/her own choosing instead of selecting one of the listed qualities 220. When the patient has chosen what he/she thinks is the physician's most valuable professional attribute, a screen is displayed, e.g., as indicated generally in FIG. 3F by reference number 224. The patient is asked to select two more qualities 220 that best describe the physician, one of which may be an “Other” quality 222 of the patient's own choosing. (A quality 220 selected by the patient from the previous screen 216 may not be shown for selection on the screen 224.)

After the patient has selected qualities 220 for the physician, a screen is displayed, e.g., as indicated generally in FIG. 3G by reference number 226. The patient is asked to select three qualities 228 that the patient thinks best describe the physician's staff. Various buttons, links, menus, areas etc. may be provided by and/or in which the patient may select three from a plurality of qualities 228. The qualities 228 are of various types, e.g., relating to professional competency, customer service, etc. In the present example embodiment, the patient may optionally enter an “Other” quality 232 of his/her own choosing instead of selecting one of the listed qualities.

After the patient has selected qualities for the physician's staff, a screen is displayed, e.g., as indicated generally in FIG. 3H by reference number 234. A list 236 is displayed of attributes 238 that the physician considers to be his/her core strengths. The patient is asked to rate each of the attributes 238 based on the patient's own experience. Specifically and for example, as shown in FIGS. 3I through 3M, the patient is asked, as to each attribute 238 individually, to indicate that the patient (a) strongly recommends the physician's practice for that attribute 238, (b) agrees as to that attribute 238, (c) is not sure about that attribute 238, or (d) disagrees as to that attribute 238.

After the patient has evaluated the physician on the attributes 238 chosen by the physician himself/herself, a screen may be displayed, e.g., as indicated generally in FIG. 3N by reference number 240. The patient may select one or more items from each of two lists 242, one list being of suggested improvements 244 that the physician might make. The patient also may select one or more of suggested improvements 246 that the physician's staff might make. In the present example embodiment, the patient may optionally enter an “Other” quality 248 of his/her own choosing on one or both lists 242 instead of selecting one of the listed qualities.

In a screen 250 shown in FIG. 3O, the patient is asked whether he/she would recommend the physician to friends and/or family. The patient may select one of the following example responses: “Of course, he is the best,” “Yes,” “Maybe,” or “No.” If the patient selects, e.g., “Of course, he is the best,” a screen 252 may be displayed, e.g., as shown in FIG. 3P. The patient is presented with options to recommend the physician by feeding the physician's “card” 254, e.g., a picture file, into one or more social media used by the patient. For example, the patient may activate one or more buttons, links, menus, areas, etc. on the screen 252 to push the physician's card 254 into Facebook®, Twitter®, and/or Google Plus. In various embodiments and as shown in FIG. 3P, the card 254 includes the physician's self-profile 214 (shown in FIG. 3D), and can include a link to the physician's provider profile 56 in the system 20. The card 254 also may include patient opinions 256 and peers' opinions 258, further described below.

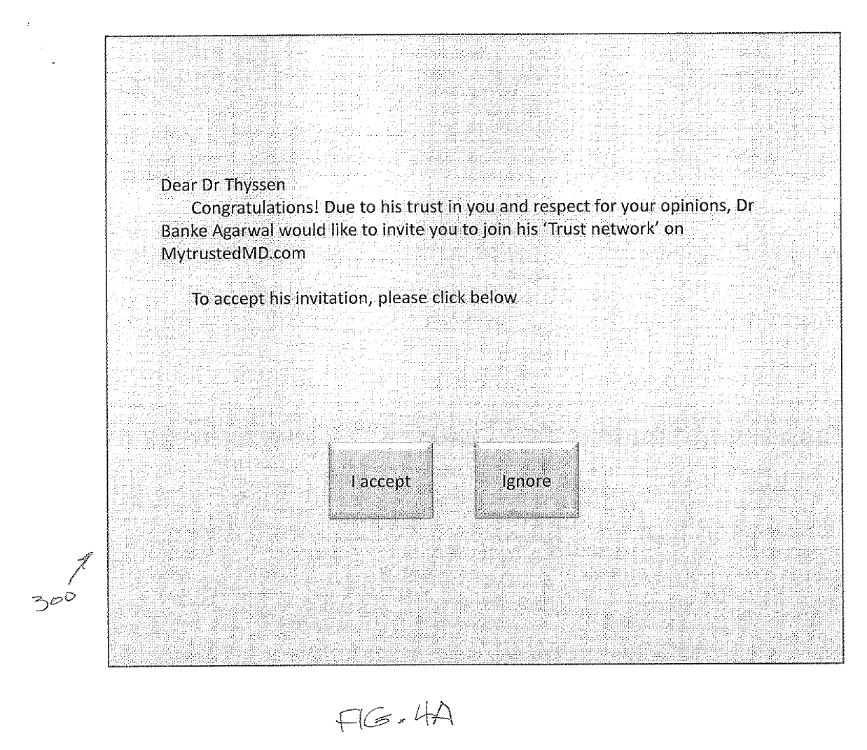

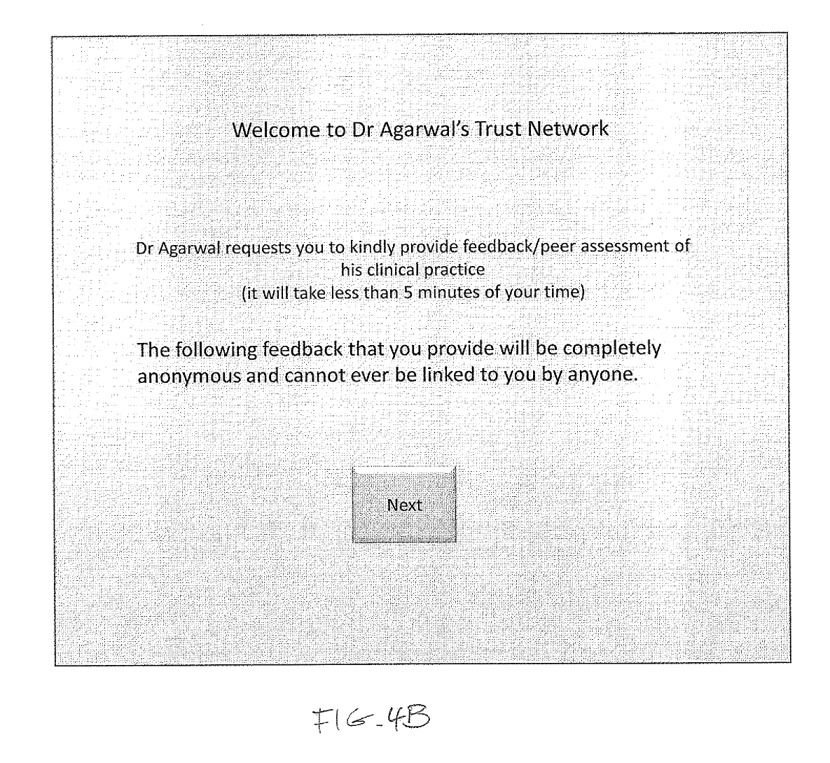

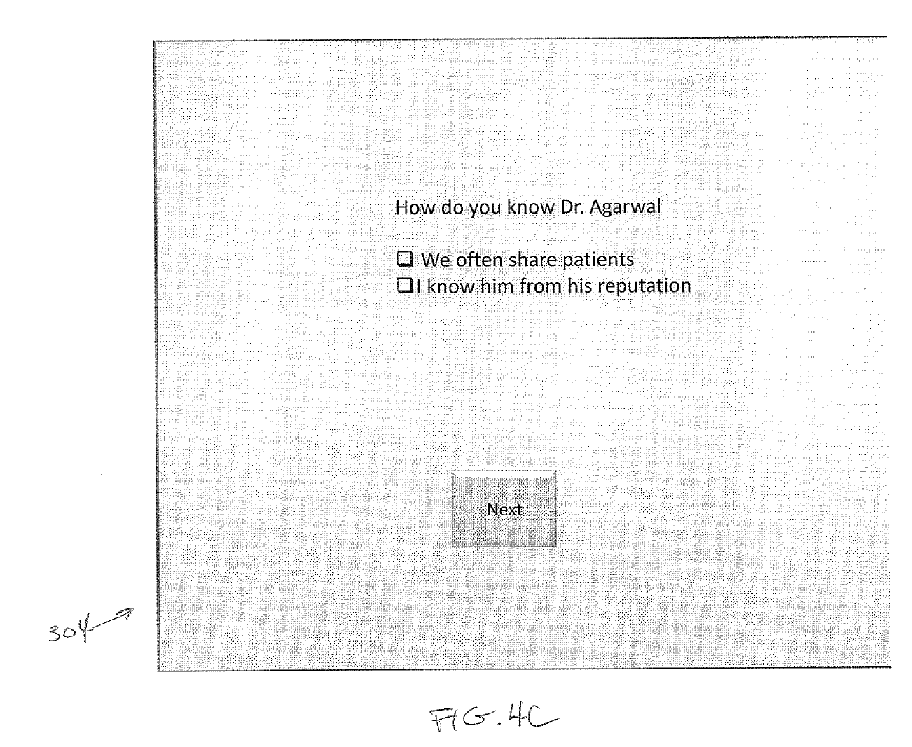

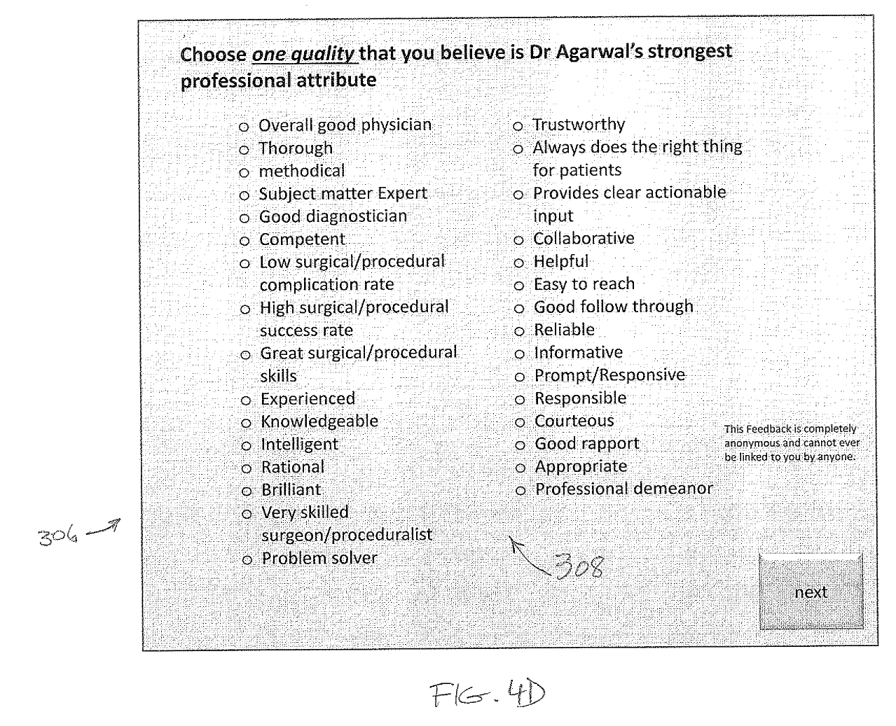

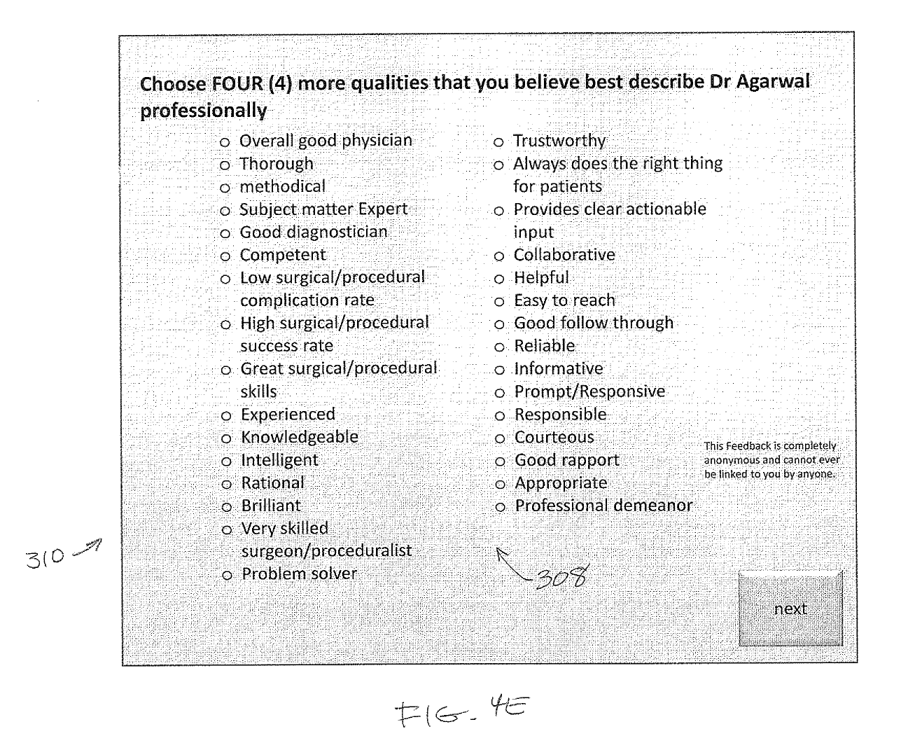

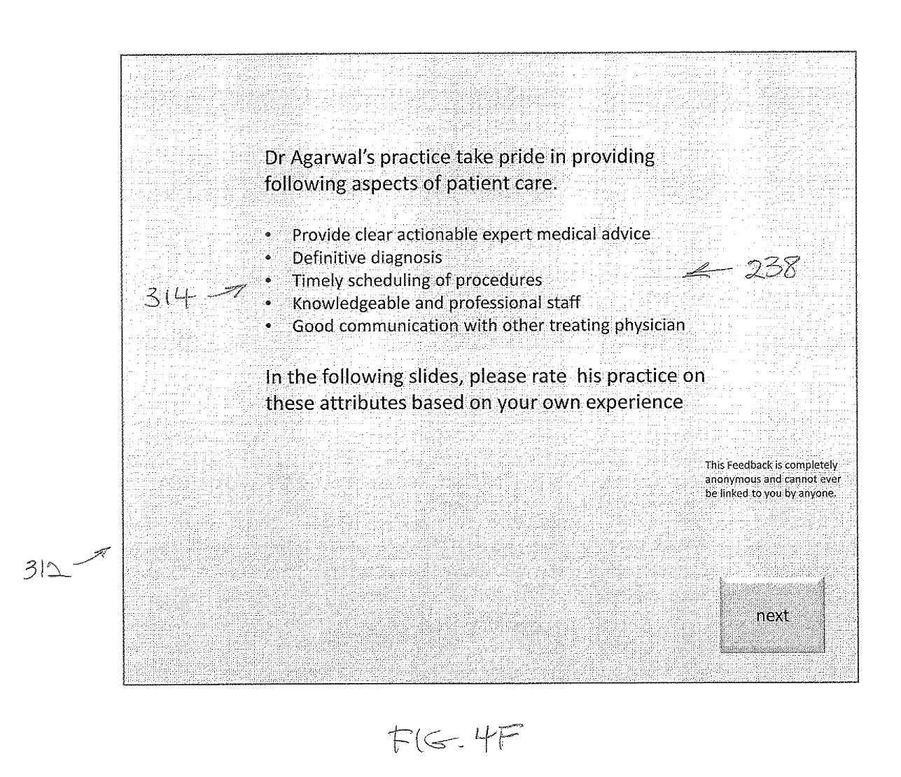

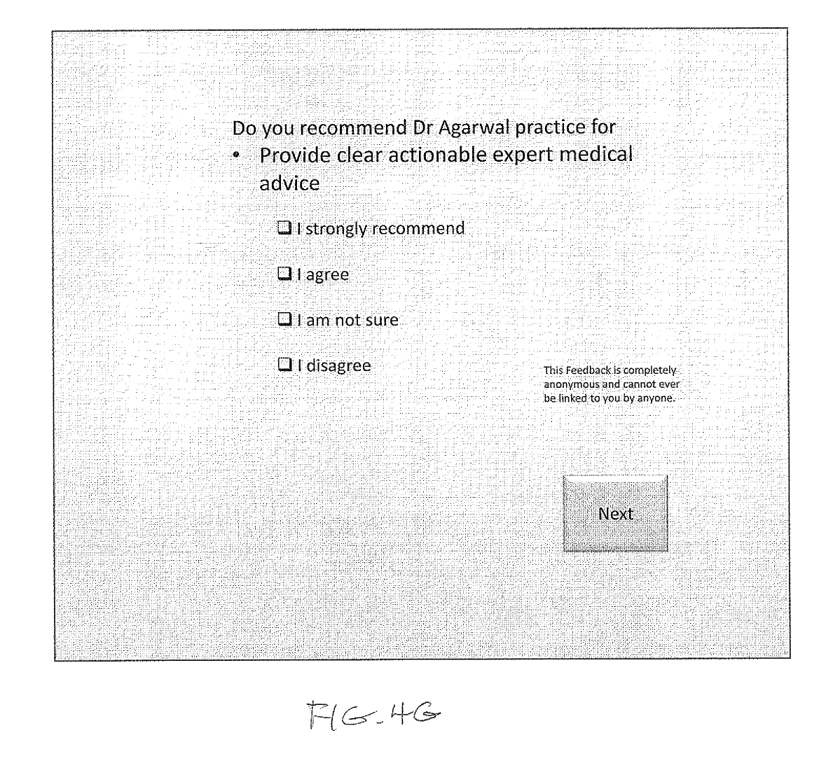

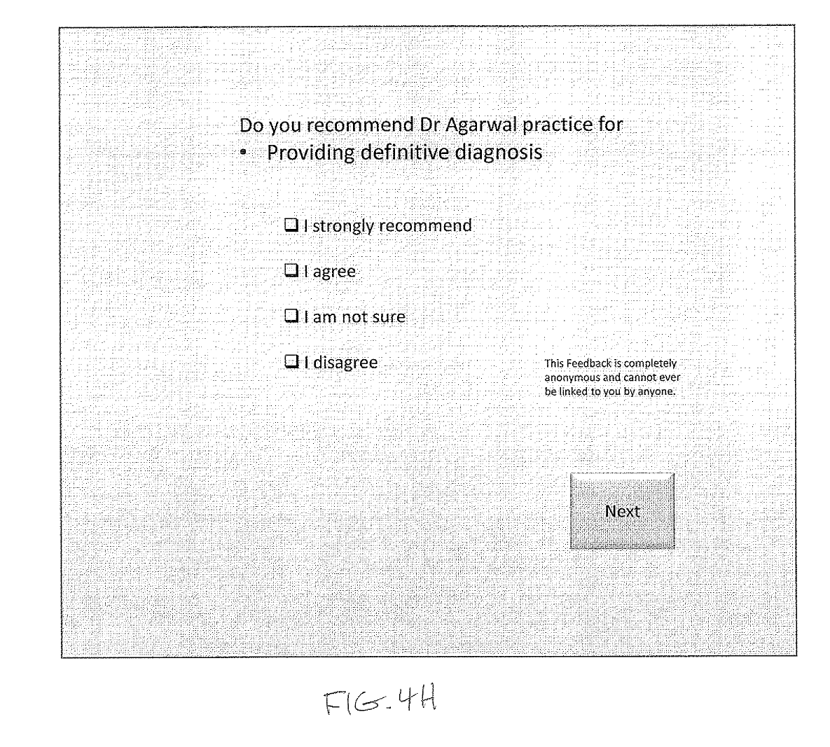

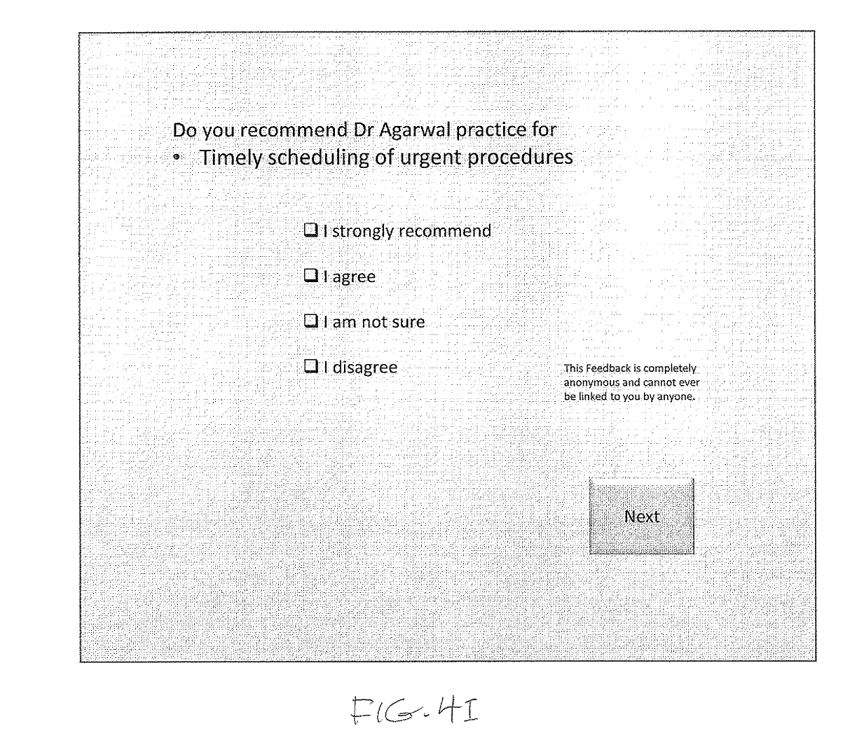

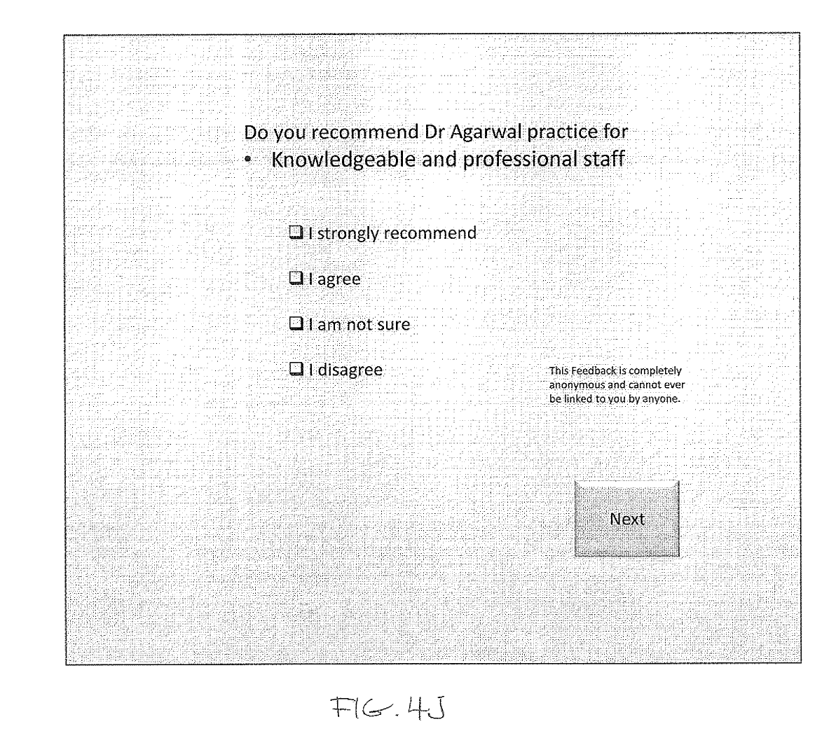

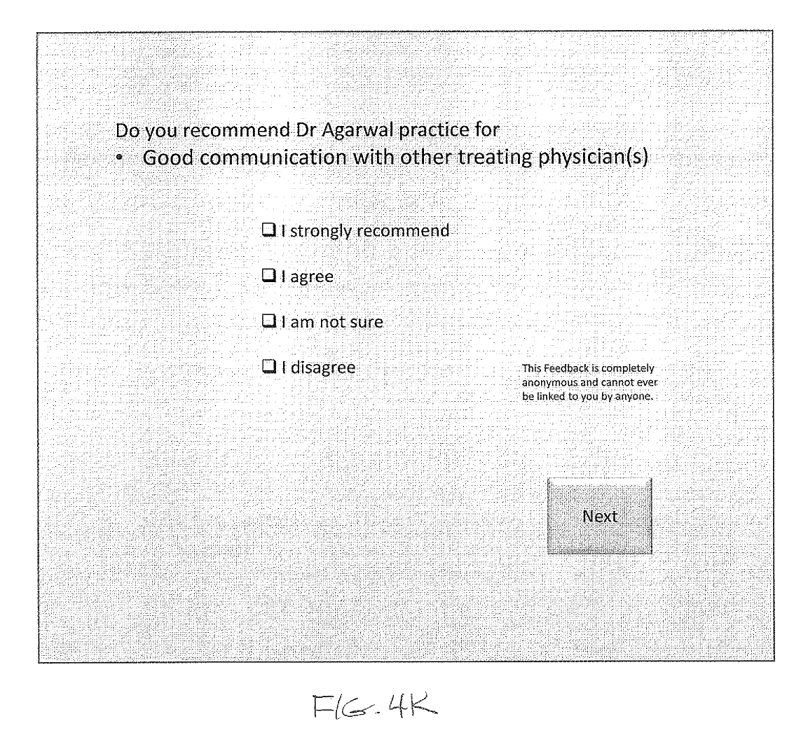

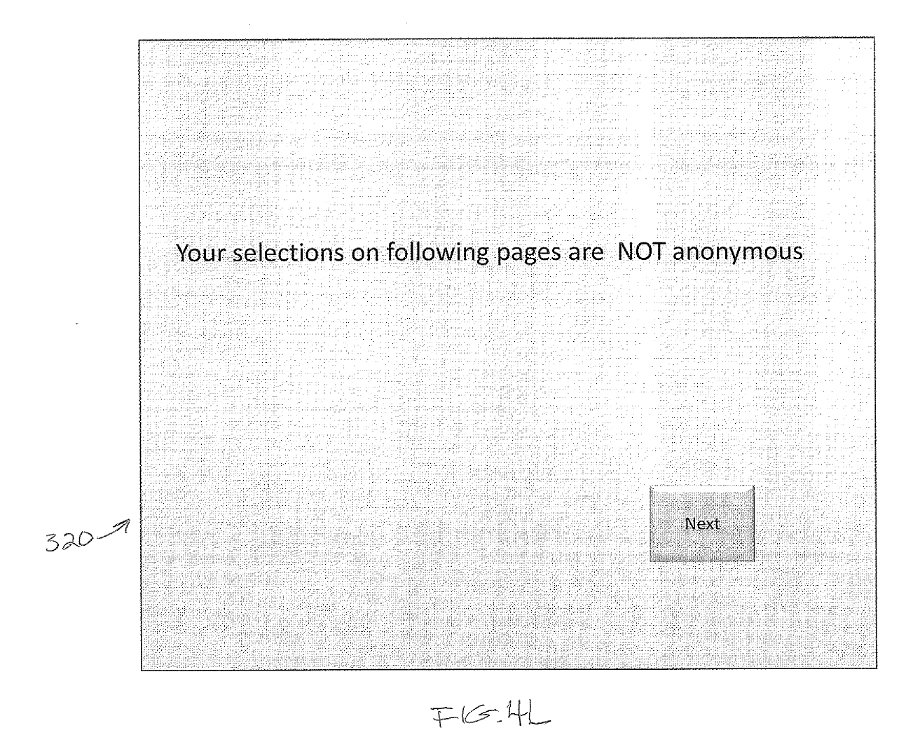

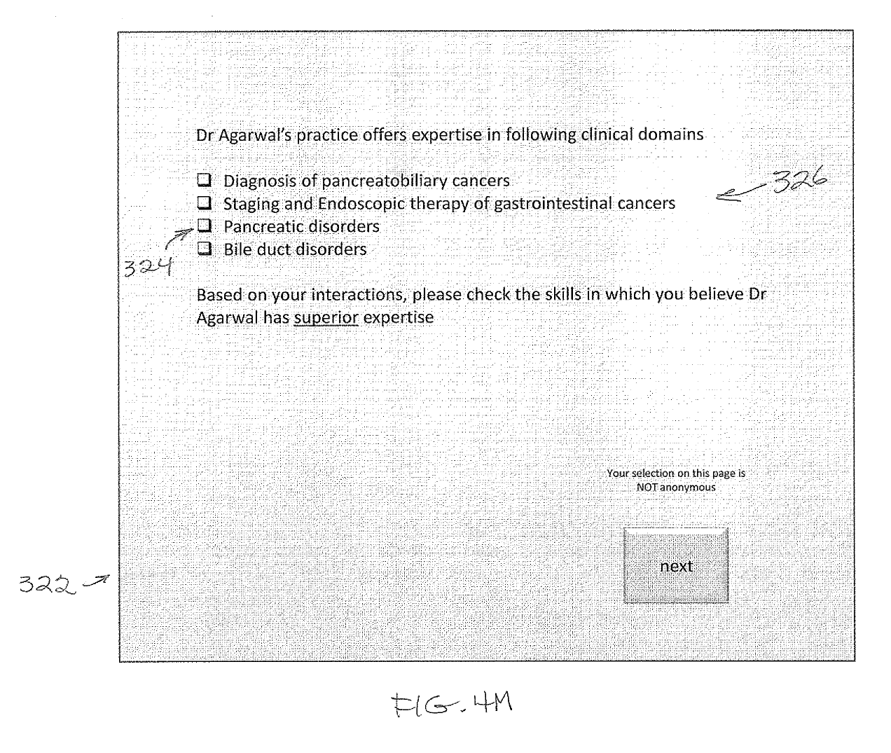

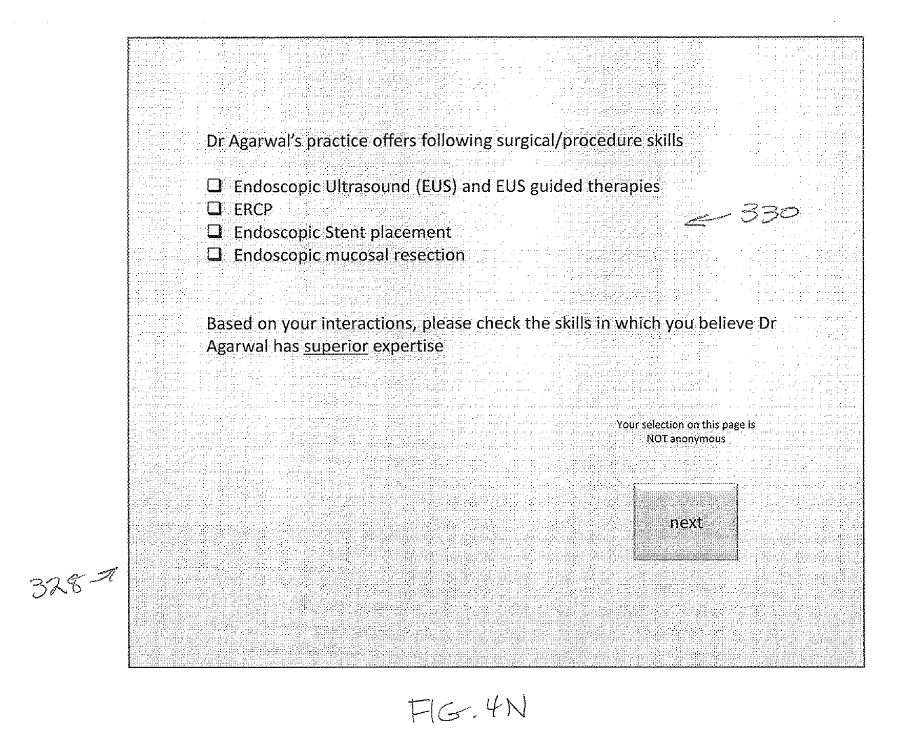

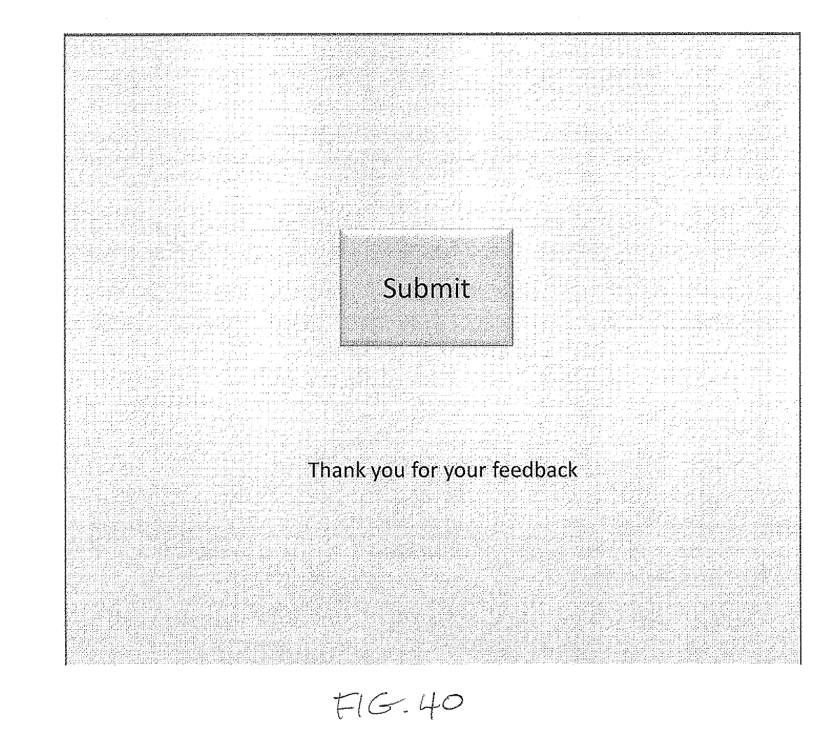

In various embodiments of the disclosure, a physician associated with the system 20 may invite a peer who may be, e.g., another doctor or professional with whom the physician works, to provide feedback about the physician to the system 20 and to join the physician's trust network of peers. A peer may provide at least some feedback anonymously to the system 20. Peer evaluation information may be received, e.g., as shown in FIGS. 4A thru 4O. The peer may accept an invitation, e.g., provided in a screen 300 shown in FIG. 4A, to join a trust network of the requesting physician. The peer is requested to provide evaluation feedback as to the physician's practice, e.g., as shown in FIG. 4B. The peer who chooses to provide feedback responds to a screen 304, shown in FIG. 4C, requesting how well the peer knows the physician. A screen then may be displayed, e.g., as indicated generally in FIG. 4D by reference number 306, in which the peer is asked to select one quality 308 that the peer thinks is the physician's strongest professional attribute. Various buttons, links, menus, areas, etc. may be provided by and/or in which the peer may select one from a plurality of qualities 308. It should be noted that the qualities 308 are of various types, e.g., relating to professional competency, personality, intelligence, character, etc. It also should be noted that in various embodiments, the qualities listed in FIG. 4D are suited for evaluation by a peer from a peer's perspective, whereas the qualities 220 listed in the screen 216 (shown in FIG. 3E) for selection therefrom by a patient are suited for evaluation by a patient from a patient's perspective. When the peer has chosen what he/she thinks is the physician's strongest professional attribute, a screen is displayed, e.g., as indicated generally in FIG. 4E by reference number 310. The peer is asked to select four more qualities 308 that the peer believes best describe the physician. (In various embodiments the quality 308 selected by the peer from the previous screen 306 is not shown on the screen 310.)

After the peer has selected qualities for the physician, a screen is displayed, e.g., as indicated generally in FIG. 4F by reference number 312. A list 314 is displayed of the attributes 238 (also shown in FIG. 3H) that the physician takes pride in providing in his/her practice. The peer is asked to rate each of the attributes 238 based on the peer's own experience. Specifically and for example, as shown in FIGS. 4G through 4K, the peer is asked, as to each attribute 238 individually, to indicate that the peer (a) strongly recommends the physician's practice for that attribute 238, (b) agrees as to that attribute 238, (c) is not sure about that attribute 238, or (d) disagrees as to that attribute 238.

Whereas information provided by the peer in response to the screens shown in FIGS. 4C through 4K is kept as anonymous information in the system 20, information may be received from a peer and attributed to the peer. In the present embodiment, after the peer has evaluated the physician on the attributes 238 chosen by the physician himself/herself, a screen may be displayed, e.g., as indicated generally in FIG. 4L by reference number 320. The peer is advised that subsequent information that may be provided by the peer will not be anonymous information. The peer may continue to display a screen, e.g., numbered as 322 in FIG. 4M. The peer may select from a list 324 one or more medical skills 326, e.g., in various clinical domains, in which the peer believes the physician has superior expertise, based on the peer's interactions with the physician. The peer then may proceed to a screen 328, shown in FIG. 4N, to select one or more surgical/procedure skills 330 in which the peer believes the physician has superior expertise, based on the peer's interactions with the physician.

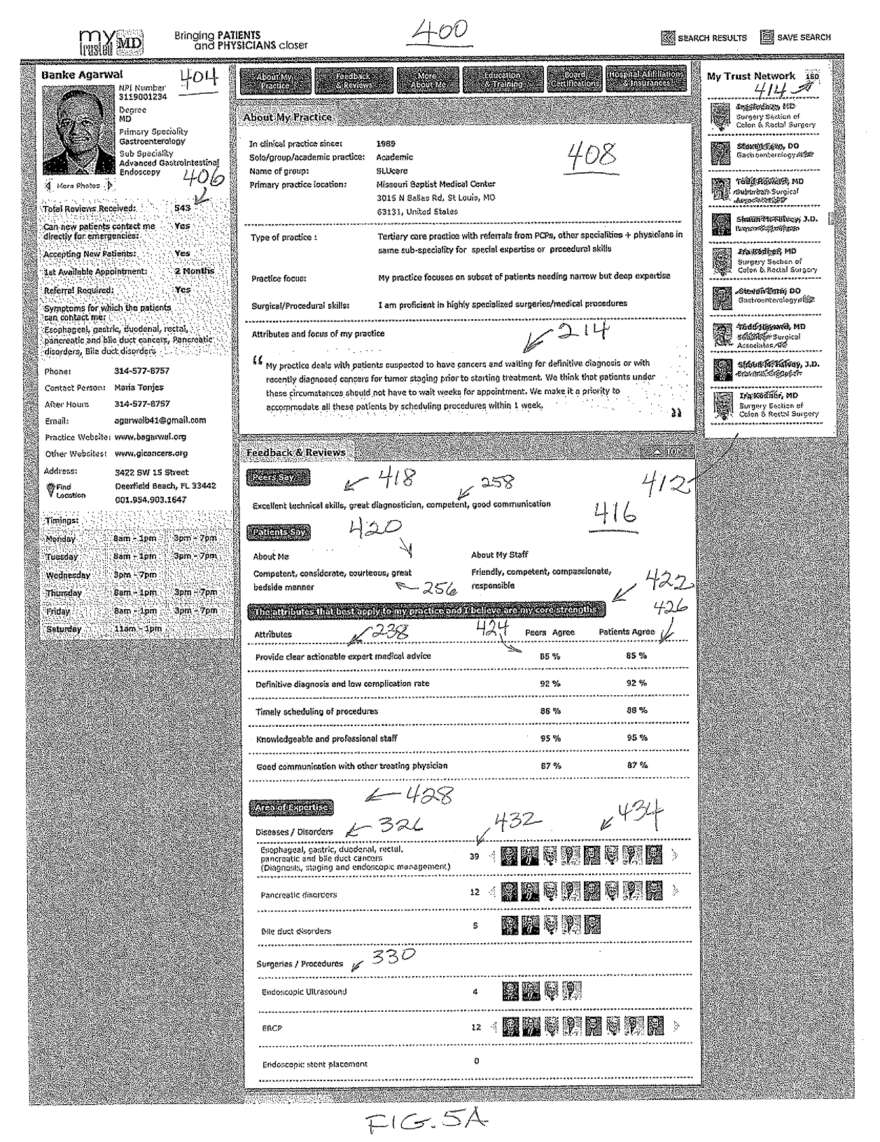

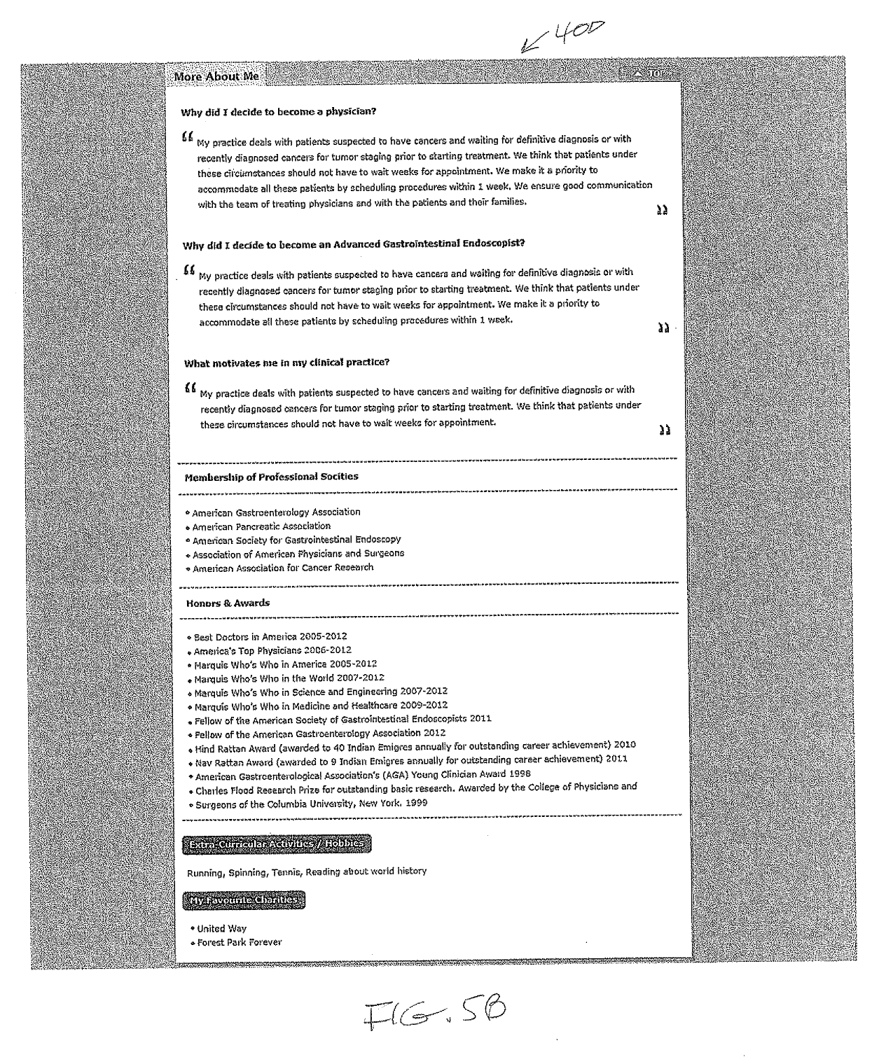

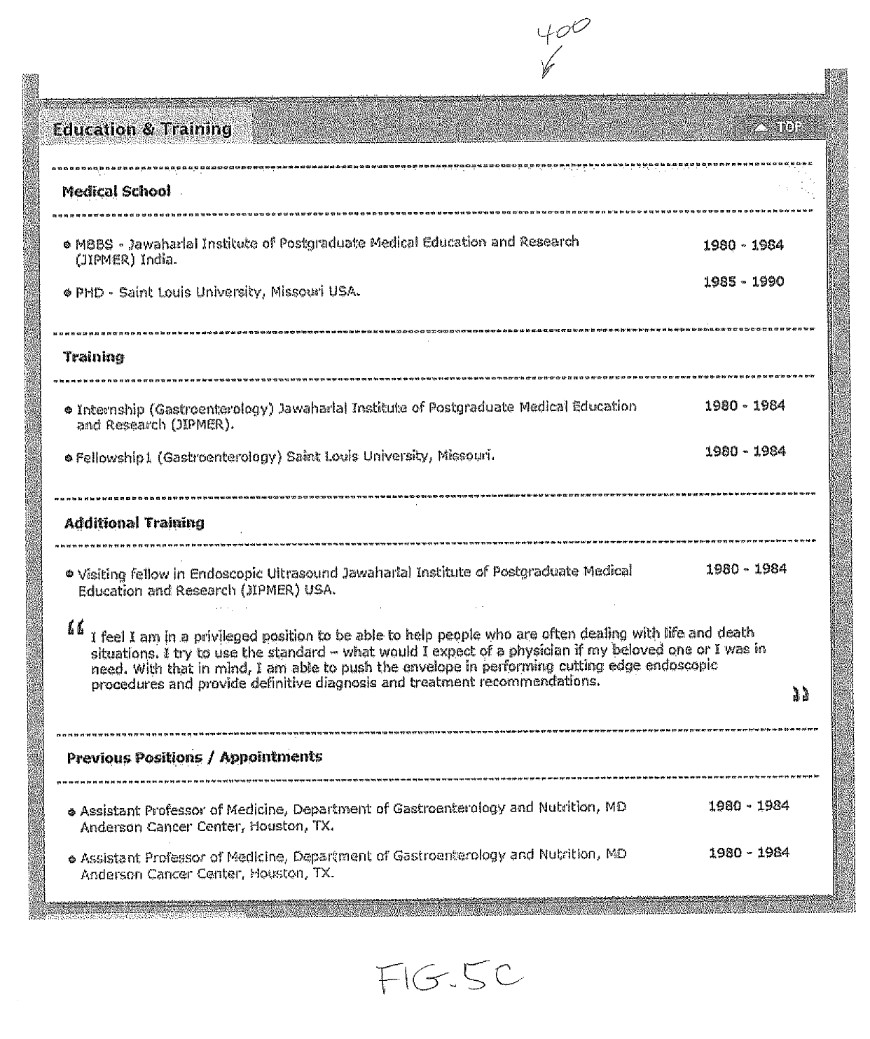

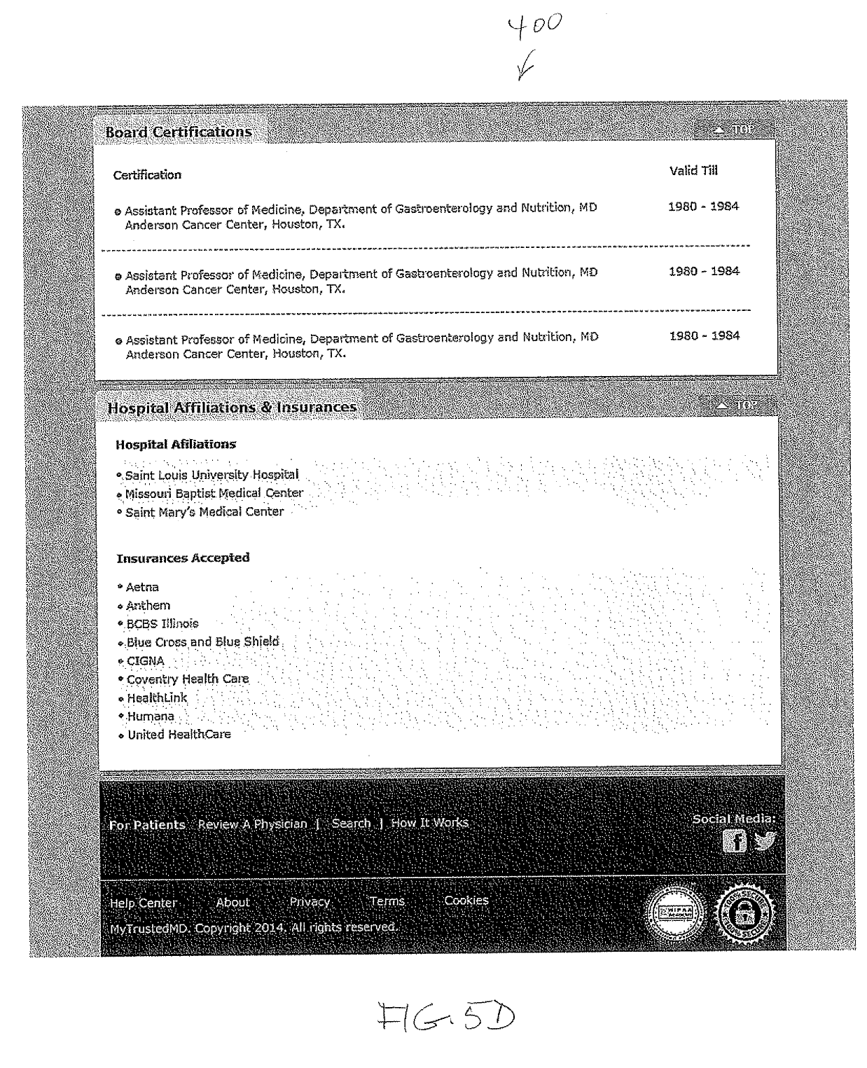

Evaluation information received from patients and peers of a physician may be accumulated, analyzed, and/or displayed in various ways and in accordance with various algorithms. For example, patient and/or peer opinions may be weighted based on proportions of patients and/or peers who share the same opinion. One example of a display of information in a physician's provider profile 56, e.g., on a website of the system 20, is indicated generally in FIGS. 5A-5D by reference number 400. Information 404 describing the physician includes a field 406 indicating the number of reviews received by the system 20 from patients of the physician. A section 408 describing the physician's practice may include the physician's self-profile 214 (also shown in FIG. 3D) including attributes and focus of the physician's practice. A trust network section 412 lists members of the physician's trust network and includes a field 414 indicating the number of peers included in the trust network. In various embodiments, a trust network section may identify peers who refer their patients to the physician, and may identify peers to whom the physician refers his own patients.

A profile section 416 includes patient and peer feedback and reviews. A section 418 describes, e.g., summarizes, what peers say about the physician and may include one or more of the qualities 308 selected, e.g., by a predetermined percentage of the physician's peers as best describing the physician, e.g., as previously discussed with reference to FIGS. 4D and 4E. A section 420 describes, e.g., summarizes, what patients say about the physician and the physician's staff. The section 420 may list, e.g., qualities 220 selected, e.g., by a predetermined percentage of the physician's patients as best describing the physician, e.g., as previously discussed with reference to FIGS. 3E and 3F, and qualities 228 selected, e.g., by a predetermined percentage of the physician's patients as best describing the physician's staff, e.g., as previously discussed with reference to FIG. 3G.

In the present example embodiment, a section 422 of the provider profile display 400 indicates opinions of the physician's patients and peers regarding the physician's self-evaluation, e.g., patients' and peers' opinions regarding attributes 238 chosen by the physician as being core strengths and best applicable to his/her practice, e.g., as previously discussed with reference to FIGS. 3H through 3M and FIGS. 4F through 4K. With each attribute 238 is listed a percentage 424 of agreement by peers and a percentage 426 of agreement by patients on whether the physician exhibits that attribute 238. In various example embodiments, a user may view various testimonials entered by patients and/or peers regarding the physician.

A provider profile display section 428 indicates areas of expertise 326 and 330 (shown in FIGS. 4M and 4N) claimed by the physician, numbers 432 of peers who believe the physician has superior expertise in the areas of expertise 326 and/or 330, and photos and/or other identifications 434 of the peers who have indicated their opinions, e.g., as previously discussed with reference to FIGS. 4L through 4N.

Provider profiles 56 may include various types of information that could be of interest to a user seeking a physician. Accordingly, the display 400 of provider profile information may include sections, e.g., as shown in FIGS. 5B-5D, of information relating, e.g., to the physician's current practice, personal and professional motivations, professional society memberships, honors and awards, hobbies and extra-curricular activities, favorite charities, education and training, employment history, board certifications, hospital affiliations, and accepted insurances. In relation to various embodiments, a user may direct search terms for searching provider profiles 56 to find such information. For example, if a user who is an athlete wishes to find a physician to treat an injury incurred while the user was running, the user may wish to find a physician who is also a runner. Of course, the types and extents of information that may be included in a provider profile can vary widely, e.g., based on the type of professional services, preferences of the provider, etc.

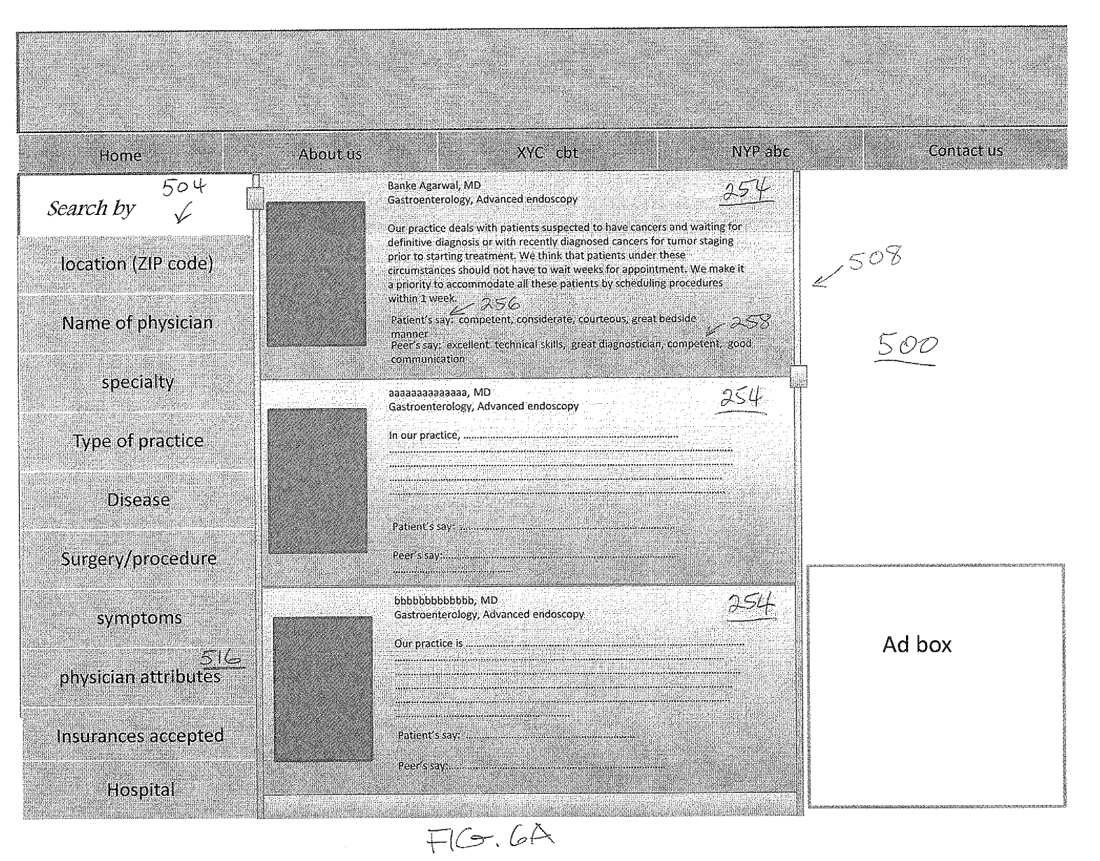

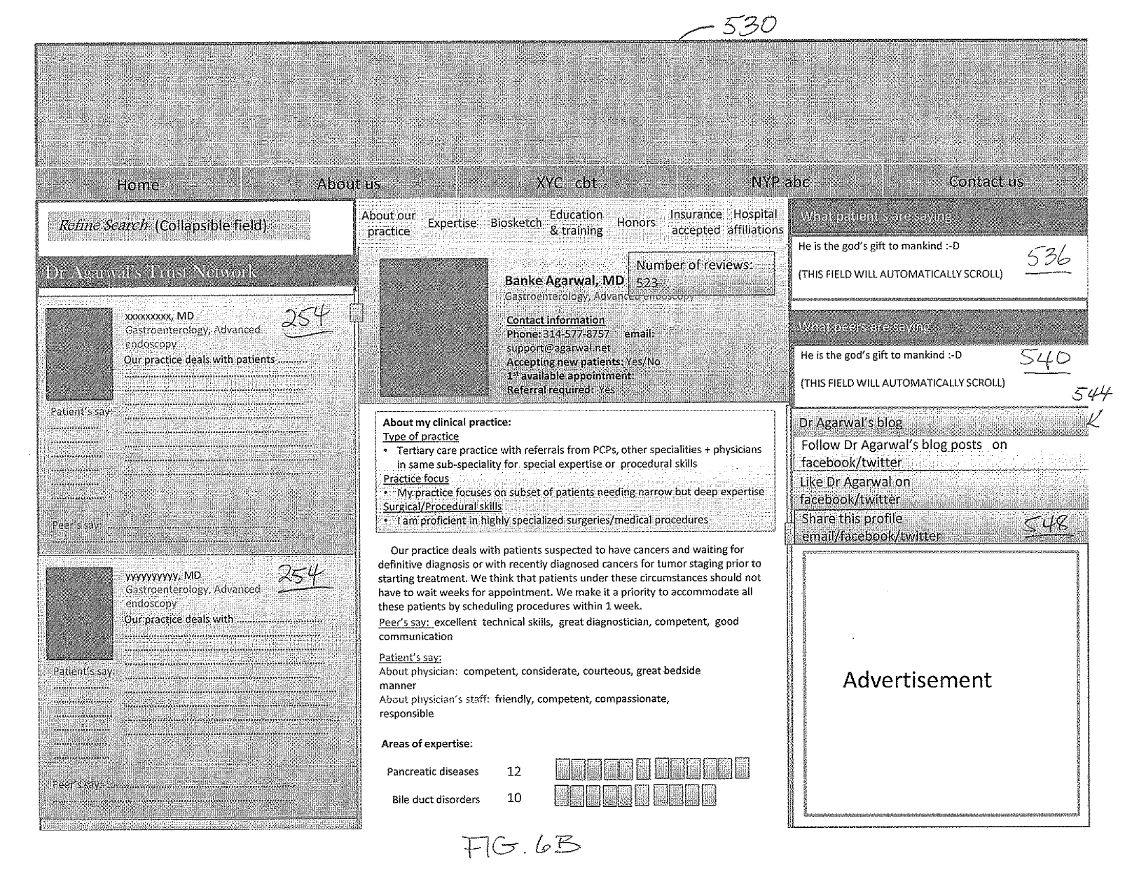

Referring again to FIG. 1 and as previously discussed, the system 20 may make a plurality of provider profiles 56 available for searching by users, e.g., through a website. One example screen that may be provided by such a website is indicated generally in FIG. 6A by reference number 500. The screen 500 displays a plurality of search categories 504 in which search parameters may be specified for finding a physician. Additionally or alternatively, various embodiments allow a user to specify search parameters without regard to any specific category 504. In the present example embodiment, results 508 of a search are shown, which may include one or more provider cards 254, e.g., as discussed with reference to FIG. 3P.

A user may perform searches for a physician based on objective search categories 504 such as specialty, disease, etc., and may additionally or alternatively perform searches based on a “physician attributes” search category 516. When the user, e.g., activates the “physician attributes” category 516, the user may enter and/or select search parameters for finding physicians whose provider profiles include attributes 238 and/or qualities 220, 228, and/or 308 that may be desired by the user. For example, if the user wishes to find a doctor who is considered by his/her patients and peers to be “compassionate,” the user may include the word “compassionate” as a search parameter. In some embodiments, when a user activates the “physician attributes” search category 516, he/she is presented with a list (not shown) of those attributes and/or qualities that have been included in and/or in relation to those provider profiles 56 that are stored in the system 20. The user may then select search parameters from the list those attributes and/or qualities that the user wishes a physician to have.

Referring again to FIG. 6A, when a user clicks on or otherwise activates a card 254 displayed for a selected physician, a screen 530 may be displayed, for example, as shown in FIG. 6B, including further information from the selected physician's provider profile 56. In the present example embodiment, the selected physician's provider profile display screen 530 includes some or all of the same or similar information as discussed with reference to FIGS. 5A through 5D. The profile display screen 530 also provides scroll fields 536 and 540 whereby a user may view some or all of the attributes 238 and/or qualities (220, 228, 308) selected by patients and/or peers for the selected physician. Other or additional display fields may include links 544 for social media utilized by the selected physician, and a link 548 whereby the user may send the physician's provider profile information to the user's social media sites. In some embodiments, the profile display screen 530 also includes cards 254 of peers in the selected physician's trust network and who also are represented by their own provider profiles 56 in the system 20.

The foregoing apparatus and systems make it possible for patients to find physicians who best meet their healthcare needs, personality preferences and customer service preferences. Many physicians have “insider information” to help them choose the best physician for their own healthcare requirements. Such information is based largely on word-of-mouth information from peers and patients. The foregoing embodiments make it possible to create authenticated “insider information” about physicians and make it freely available online. This is in contrast to a number of “physician rating” sites at which unreliable and unauthenticated information may be provided. The inventor has observed that many if not most “physician rating” sites do not verify whether “patients” who evaluate a physician are actual patients. Such websites may be subject to reviewer bias and may tend to focus on customer service rather than providing a realistic assessment of physician skills. Results may be provided that are not meaningful in view of the wide diversity among physicians' practices and the wide diversity among the needs of patients.

The foregoing embodiments make it possible to provide a review system in which review parameters are pertinent to an individual physician's practice. Parameters for patient and peer review can be formulated and chosen by the physician for evaluation of his/her clinical practice, and the physician's patients and peers can provide anonymous evaluation of how well the physician meets those criteria. Reviews can be received from real patients who are authenticated as such and who are encouraged by the treating physician to provide reviews. Patient reviews are anonymous, allowing patients to be frank in their reviews. Further, in various embodiments, online feedback can be received from patients without triggering violations of the HIPAA (Health Insurance Portability and Accountability Act). In various embodiments, physicians invite those physicians with whom they closely work into their trust networks. Patients then can learn about a physician by the company he/she keeps and works closely with. Peers can anonymously review the physician and endorse him/her for specific clinical skills in which the physician has superior ability. Prospective patients thus can get an idea as to the physician's competency and clinical skills.

Various embodiments of the foregoing apparatus and methods make it possible to identify not only an individual physician's character strengths, but also his/her clinical competencies. In various review system embodiments, data may be acquired from multiple independent sources. Various algorithms may be used to analyze such data, not only for consistency, but also to determine the most informative ways in which to make the data available to users. Physicians can be judged not only on what is said about them but also on the consistency and congruency of what is said. In various embodiments in which a summary of reviews reflects an opinion of a majority of patients treated by a physician, such an opinion would not be inordinately influenced by extreme views about the physician. It would be very difficult for someone to manipulate a review system configured in accordance with various embodiments of the disclosure.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A system comprising:
a network; and
one or more computers configured in the network to:
receive user input at a website, the input describing one or more service provider qualities and/or attributes;
compare the user input with stored qualities and/or attributes corresponding to a plurality of service providers, the stored qualities and/or attributes having been specified in response to requests by the system for qualitative information from individuals determined by the system to have personal knowledge of service providers described in the system, the individuals included in a plurality of groups, each group treated by the system as having a corresponding perspective from which to evaluate service providers, at least some of the qualitative information having been specified as to a given provider in response to a self-evaluation by the given provider with respect to one or more of the stored qualities and/or attributes; and
based on the comparing, identifying one or more service providers described in the system as having one or more of the service provider qualities and/or attributes input by the user.

2. The system of claim 1, wherein the providers and a first of the groups include physicians and a second of the groups includes patients of the providers.

3. The system of claim 1, wherein the network is configured to verify evaluators in the groups as members of the groups, and to maintain as anonymous at least some of the qualitative information specified by the evaluators.

4. The system of claim 1, wherein at least some of the qualitative information includes a provider quality or attribute specified by one of the providers or one of the individuals of one of the groups, the system further configured to add the specified quality or attribute to the stored qualities and/or attributes.

5. The system of claim 1, wherein some of the stored qualities and/or attributes include one or more of the following: qualities personal to a provider, and qualities of a provider's staff.

6. The system of claim 1, wherein the website is configured to list areas of a provider's expertise as indicated by peer evaluators of the provider.

7. A system for providing information by which to evaluate providers of professional services, the system comprising:
a network; and
one or more computers configured in the network to provide a website for receiving input requested from a plurality of evaluators to evaluate a plurality of providers of professional services, where for each provider:
the evaluators of the provider include the provider, clients of the provider, and peers of the provider;
the website is configured to present, to each client evaluator and to each peer evaluator, one or more professional attributes selected by the provider as the provider's professional attributes;
as to each professional attribute selected by the provider, the website is configured to request each client evaluator and each peer evaluator to provide an opinion as to whether the evaluator recommends the provider for that professional attribute;
the website is configured to request each client evaluator and each peer evaluator to select one or more qualities as best describing the provider; and
the website is configured to provide an evaluation of the provider that indicates (a) the most commonly provided opinions as to the provider-selected professional attributes, and (b) the qualities most commonly selected as best describing the provider.

8. The system of claim 7, wherein the providers and peers include medical doctors and the clients include medical patients.

9. The system of claim 7, wherein the website is searchable by a user to find a provider from among the plurality of providers by searching for desired attributes and qualities from among the professional attributes and qualities indicated in the evaluations of the providers.

10. The system of claim 7, configured to verify client evaluators of the providers as provider clients, and to maintain as anonymous input the input of the client evaluators.

11. The system of claim 7, wherein the one or more qualities are selectable from a plurality of qualities including one or more of the following: qualities personal to a provider, and qualities of a provider's staff.

12. The system of claim 7, wherein the website is configured to list areas of a provider's expertise as indicated by peer evaluators of the provider.

13. The system of claim 7, wherein at least some of the input of the peer evaluators is maintained in the system as anonymous input.

14. A system for facilitating evaluation of providers of professional services, the system comprising:
a network; and
one or more computers configured in the network to:
request online input from each of a plurality of evaluators to evaluate a plurality of providers of professional services, where for each provider, evaluators include the provider, clients of the provider, and peers of the provider, and where the peers and clients are requested to provide at least some of the input confidentially in qualitative terms;
receive confidentially from each client evaluator (a) an evaluation of a self-evaluation by the provider and (b) an evaluation of the provider from the perspective of the client evaluator as a client of the provider;
receive confidentially from each peer evaluator (a) an evaluation of the self-evaluation by the provider and (b) an evaluation of the provider from the perspective of the peer evaluator as a peer of the provider;
analyze the qualitative terms provided in the evaluations to determine a plurality of the qualitative terms describing the provider; and
provide the qualitative terms in a computer-searchable format.

15. The system of claim 14, wherein the providers and peers include medical doctors and the clients include medical patients.

16. The system of claim 14, wherein at least some of the qualitative terms are provided to the system by the provider.
